(19) United States
(12) Patent Application Publication
(10) Pub. No.: US 2019/0199226 A1
(43) Pub. Date: Jun. 27, 2019

(54) VOLTAGE CONVERTING DEVICE AND METHOD OF CONTROLLING THE VOLTAGE CONVERTING DEVICE

(71) Applicant: XIAMEN KEHUA HENGSHENG LIMITED BY SHARE LTD., Xiamen (CN)

(72) Inventors: Jiangyong Huang Zhan, Xiamen (CN); Longqiang Yi, Xiamen (CN); Zhidong Wang, Xiamen (CN); Jinrong Wu, Xiamen (CN); Qingbin Wu, Xiamen (CN); Xiaofan Zhong, Xiamen (CN); Haiquan Lian, Xiamen (CN)

(21) Appl. No.: 16/229,922

(22) Filed: Dec. 21, 2018

(30) Foreign Application Priority Data
Dec. 22, 2017 (CN) 201711404269.6
Dec. 22, 2017 (CN) 201711406133.9
Dec. 22, 2017 (CN) 201711406162.5
Dec. 22, 2017 (CN) 201711406600.8
Dec. 22, 2017 (CN) 201711407593.3
Dec. 22, 2017 (CN) 201711407633.4

(51) Int. Cl. H02M 3/335; H02J 3/38; H02J 7/35; H02M 1/08

(52) U.S. Cl. CPC H02M 3/33584; H02M 1/083; H02J 7/35; H02J 3/383

(57) ABSTRACT

A voltage converting device includes: a first power supply, having a first positive terminal and a first negative terminal; a first bridge circuit, coupled to the first positive terminal; a second bridge circuit, coupled between the first bridge circuit and the first negative terminal; a second power supply, having a second positive terminal and a second negative terminal; a third bridge circuit, coupled to the second positive terminal; a fourth bridge circuit, coupled between the third bridge circuit and the second negative terminal; and an inductive circuit, coupled between the first bridge circuit and the second bridge circuit.

### BACKGROUND

A DCDC converting device is arranged to convert a source of direct current (DC) from one voltage level to another voltage levels. The DCDC converting device may be used in the field of solar power to up-convert (i.e. Boost) or down-convert (i.e. Buck) the voltage level of the direct current. Currently, a DCDC converting device is either a Boost convert or a Buck converter. Moreover, in a system with a relatively high operating voltage level, e.g. 1000V or higher, the cost of the high-voltage switching device is relatively high.

In addition, for the example of a Buck converter, when the output loading is full, the Buck converter may operate in the continuous current mode (CCM). The output loading current may be the average current of the inductor current. When the loading current decreases, the average current of the inductor current also decreases. When the average current of the inductor current reaches a specific value, the Buck convert enter the threshold current mode. If the loading current further decreases, and the inductor current reaches zero and the switching cycle is not finished yet, then the inductor current may be kept on the zero current for some time due to the diode. When the switching cycle finishes, the Buck converter enter the next switching cycle, and the next switching cycle may be the discontinuous current mode (DCM). The conventional Boost converter or Buck converter only operates in the discontinuous current mode when the loading current is small. When the loading current is small, the sampling of the inductor current may be inaccurate due to the discontinuity of the inductor current. Accordingly, the loop bandwidth of the Buck converter is relatively small, and oscillation may occur in the system.

### SUMMARY

Embodiments of the present invention provide a voltage converting device. The voltage converting device comprises: a first power supply, having a first positive terminal and a first negative terminal; a first bridge circuit, coupled to the first positive terminal; a second bridge circuit, coupled between the first bridge circuit and the first negative terminal; a second power supply, having a second positive terminal and a second negative terminal; a third bridge circuit, coupled to the second positive terminal; a fourth bridge circuit, coupled between the third bridge circuit and the second negative terminal; and an inductive circuit, coupled between the first bridge circuit and the second bridge circuit.

In one embodiment, the first power supply is a power battery pack and the second power supply is a photovoltaic system.

In one embodiment, the first bridge circuit comprises: a first capacitor, having a first terminal coupled to the first positive terminal; a first switching transistor, having a first terminal coupled to the first terminal of the first capacitor; a second switching transistor, having a first terminal coupled to a second terminal of the first switching transistor, and a second terminal coupled to a second terminal of the first capacitor. The second bridge circuit comprises: a second capacitor, having a first terminal coupled to the second terminal of the first capacitor, and a second terminal coupled to the first negative terminal of the first power supply; a third switching transistor, having a first terminal coupled to the first terminal of the second capacitor; a fourth switching transistor, having a first terminal coupled to a second terminal of the third switching transistor, and a second terminal coupled to the second terminal of the first capacitor. The third bridge circuit comprises: a third capacitor, having a first terminal coupled to the second positive terminal; a fifth switching transistor, having a first terminal coupled to the first terminal of the third capacitor; a sixth switching transistor, having a first terminal coupled to a second terminal of the fifth switching transistor, and a second terminal coupled to a second terminal of the third capacitor. The fourth bridge circuit comprises: a fourth capacitor, having a first terminal coupled to the second terminal of the third capacitor, and a second terminal coupled to the second negative terminal of the second power supply; a seventh switching transistor, having a first terminal coupled to the first terminal of the fourth capacitor; an eighth switching transistor, having a first terminal coupled to a second terminal of the seventh switching transistor, and a second terminal coupled to the second terminal of the fourth capacitor. The inductive circuit comprises: a first inductor, having a first terminal coupled to the second terminal of the first switching transistor, and a second terminal coupled to the second terminal of the fifth switching transistor; and a second inductor, having a first terminal coupled to the second terminal of the third switching transistor, and a second terminal coupled to the second terminal of the seventh switching transistor.

In one embodiment, the first capacitor, the second capacitor, the third capacitor, and the fourth capacitor have a first capacitance, a second capacitance, a third capacitance, and a fourth capacitance respectively, the first capacitance is equal to the second capacitance, and the third capacitance is equal to the fourth capacitance.

In one embodiment, the second terminal of the second switching transistor is coupled to the second terminal of the sixth switching transistor.

In one embodiment, the voltage converting device further comprises: a first connecting circuit, coupled to the first positive terminal, the first negative terminal, the first bridge circuit, and the second bridge circuit; and a second connecting circuit, coupled to the second positive terminal, the second negative terminal, the third bridge circuit, and the fourth bridge circuit.

In one embodiment, the first bridge circuit comprises: a first capacitor, having a first terminal coupled to the first positive terminal; a first switching transistor, having a first terminal coupled to the first terminal of the first capacitor, and a second terminal coupled to a second terminal of the first capacitor; a second capacitor, having a first terminal coupled to the second terminal of the first capacitor; a second switching transistor, having a first terminal coupled to the first terminal of the second capacitor, and a second terminal coupled to a second terminal of the first capacitor. The second bridge circuit comprises: a third capacitor, having a first terminal coupled to the second terminal of the second capacitor; a third switching transistor, having a first terminal coupled to the first terminal of the third capacitor, and a second terminal coupled to a second terminal of the third capacitor; a fourth capacitor, having a first terminal coupled to the second terminal of the third capacitor; a fourth switching transistor, having a first terminal coupled to the first terminal of the fourth capacitor, and a second terminal coupled to a second terminal of the fourth capacitor. The third bridge circuit comprises: a fifth capacitor, having a first terminal coupled to the second positive terminal; a fifth switching transistor, having a first terminal coupled to the first terminal of the fifth capacitor, and a second terminal coupled to a second terminal of the fifth capacitor; a sixth capacitor, having a first terminal coupled to the second terminal of the fifth capacitor; a sixth switching transistor, having a first terminal coupled to the first terminal of the sixth capacitor, and a second terminal coupled to a second terminal of the sixth capacitor. The fourth bridge circuit comprises: a seventh capacitor, having a first terminal coupled to the second terminal of the sixth capacitor; a seventh switching transistor, having a first terminal coupled to the first terminal of the seventh capacitor, and a second terminal coupled to a second terminal of the seventh capacitor; an eighth capacitor, having a first terminal coupled to the second terminal of the seventh capacitor; an eighth switching transistor, having a first terminal coupled to the first terminal of the eighth capacitor, and a second terminal coupled to a second terminal of the eighth capacitor. The inductive circuit comprises: an inductor, having a first terminal coupled to the second terminal of the second switching transistor, and a second terminal coupled to the second terminal of the sixth switching transistor.

In one embodiment, the first capacitor, the second capacitor, the third capacitor, the fourth capacitor, the fifth capacitor, the sixth capacitor, the seventh capacitor, and the eighth capacitor have a first capacitance, a second capacitance, a third capacitance, a fourth capacitance, a fifth capacitance, a sixth capacitance, a seventh capacitance, and an eighth capacitance respectively, the first capacitance and the second capacitance are equal to the third capacitance and the fourth capacitance respectively, and the fifth capacitance and the sixth capacitance are equal to the seventh capacitance and the eighth capacitance respectively.

In one embodiment, the first connecting circuit comprises: a ninth capacitor, having a first terminal coupled to the first positive terminal; a tenth capacitor, having a first terminal coupled to a second terminal of the ninth capacitor, and a second terminal coupled to the first negative terminal; an eleventh capacitor, having a first terminal coupled to the second terminal of the first capacitor, and a second terminal coupled to the second terminal of the third capacitor; a first diode, having an anode coupled to the second terminal of the ninth capacitor, and a cathode coupled to the first terminal of the eleventh capacitor; and a second diode, having an anode coupled to the second terminal of the eleventh capacitor, and a cathode coupled to the second terminal of the ninth capacitor. The second connecting circuit comprises: a twelfth capacitor, having a first terminal coupled to the second positive terminal; a thirteenth capacitor, having a first terminal coupled to a second terminal of the twelfth capacitor, and a second terminal coupled to the second negative terminal; a fourteenth capacitor, having a first terminal coupled to the second terminal of the fifth capacitor and a second terminal coupled to the seventh capacitor; a third diode, having an anode coupled to the second terminal of the twelfth capacitor, and a cathode coupled to the first terminal of the fourteenth capacitor; and a fourth diode, having an anode coupled to the second terminal of the fourteenth capacitor, and a cathode coupled to the second terminal of the twelfth capacitor.

A method of controlling a voltage converting device is provided. The voltage converting device comprises: a first power supply, having a first positive terminal and a first negative terminal; a first bridge circuit, having a first switching transistor and a second switching transistor, coupled to the first positive terminal; a second bridge circuit, having a third switching transistor and a fourth switching transistor, coupled between the first bridge circuit and the first negative terminal; a second power supply, having a second positive terminal and a second negative terminal; a third bridge circuit, having a fifth switching transistor and a sixth switching transistor, coupled to the second positive terminal; a fourth bridge circuit, having a seventh switching transistor and an eight switching transistor, coupled between the third bridge circuit and the second negative terminal; and an inductive circuit, coupled between the first bridge circuit and the second bridge circuit. The method comprises: receiving a request for discharging current to the second power supply from the first power supply; detecting a first voltage level of the first power supply and a second voltage level of the second power supply; when the first voltage level is smaller than the second voltage level: controlling the voltage converting device to operate in a first cycle having a first time interval T1 and a second time interval T2; during the second time interval T2, detecting if a current of the inductive circuit crosses a zero current; when the current crosses the zero current in the second time interval T2, controlling the voltage converting device to operate in a second cycle having a third time interval T3 and a fourth time interval T4 or a third cycle having a seventh time interval T7 and an eighth interval T8 after the second time interval T2; when the first voltage level is higher than the second voltage level: controlling the voltage converting device to operate in a fourth cycle having a fifth time interval T5 and a sixth time interval T6; during the sixth time interval T6, detecting if the current of the inductive circuit crosses the zero current; when the current crosses the zero current in the sixth time interval T6, controlling the voltage converting device to operate in a fifth cycle having the third time interval T3 and the fourth time interval T4 or a sixth cycle having the seventh time interval T7 and the eighth interval T8, or a seventh cycle having the third time interval T3 and the fourth time interval T4 after the sixth time interval T6.

In one embodiment, wherein: during the first time interval T1, the first switching transistor and the sixth switching transistor are turned on, the second switching transistor and the fifth switching transistor are turned off; during the second time interval T2, the sixth switching transistor is turned off; during the third time interval T3, the fifth switching transistor is turned on, the second switching transistor and the sixth switching transistor are turned off; during the fourth time interval T4, the second switching transistor and the fifth switching transistor are turned off; during the fifth time interval T5, the first switching transistor is turned on, the second switching transistor and the sixth switching transistor are turned off; during the sixth time interval T6, the first switching transistor and the sixth switching transistor are turned off; during the seventh time interval T7, the second switching transistor and the fifth switching transistor are turned on, the first switching transistor and the sixth switching transistor are turned off; during the eighth time interval T8, the second switching transistor is turned off; wherein the fourth switching transistor and the first switching transistor are controlled by a first signal, the third switching transistor and the second switching transistor are controlled by a second signal, the eight switching transistor and the fifth switching transistor are controlled by a third signal, and the seventh switching transistor and the sixth switching transistor are controlled by a fourth signal.

In one embodiment, wherein, during a cycle having time intervals T1, T2, T3, T4, the voltage converting device is arranged to operate in the third interval T3 before the current crosses the zero current; during a cycle having time intervals T1, T2, T7, T8, the voltage converting device is arranged to operate in the seventh interval T7 before the current crosses the zero current; during a cycle having time intervals T5, T6, T7, T8, the voltage converting device is arranged to operate in the seventh interval T7 before the current crosses the zero current; and during a cycle having time intervals T5, T6, T3, T4, the voltage converting device is arranged to operate in the third interval T3 before the current crosses the zero current.

In one embodiment, wherein, during a cycle having time intervals T1, T2, T3, T4, the fifth switching transistor is turned on and the second switching transistor is turned off in the second interval T2; during a cycle having time intervals T1, T2, T7, T8, the second switching transistor and the fifth switching transistor are turned on in the second interval T2; during a cycle having time intervals T5, T6, T7, T8, the second switching transistor and the fifth switching transistor are turned on in the sixth interval T6; and during a cycle having time intervals T5, T6, T3, T4, the fifth switching transistor is turned on and the second switching transistor is turned off in the sixth interval T6.

In one embodiment, wherein, during the cycle having time intervals T1, T2, T3, T4, the first switching transistor and the sixth switching transistor are turned on in the fourth interval T4; during the cycle having time intervals T1, T2, T7, T8, the first switching transistor and the sixth switching transistor are turned on in the eighth interval T8; during the cycle having time intervals T5, T6, T7, T8, the first switching transistor is turned on and the sixth switching transistor is turned off in the eighth interval T8; and during the cycle having time intervals T5, T6, T3, T4, the first switching transistor and the sixth switching transistor are turned off in the fourth interval T4.

In one embodiment, wherein the first switching transistor is turned off in the second interval T2, and the fifth switching transistor is turned off in the eighth interval T8.

In one embodiment, wherein the first switching transistor is turned on in the third interval T3, and the fifth switching transistor is turned on in the fifth interval T5.

In one embodiment, wherein: during the first time interval T1, the first bridge circuit and the fourth bridge circuit are turned on, and the second bridge circuit and the third bridge circuit are turned off; during the second time interval T2, the fourth bridge circuit is turned off, and the first bridge circuit and the second bridge circuit are not turned on at the same time; during the third time interval T3, the third bridge circuit is turned on, and the second bridge circuit and the fourth bridge circuit are turned off; during the fourth time interval T4, the second bridge circuit and the third bridge circuit are turned off; during the fifth time interval T5, the first bridge circuit is turned on, and the second bridge circuit and the fourth bridge circuit are turned off; during the sixth time interval T6, the first bridge circuit and the fourth bridge circuit are turned off; during the seventh time interval T7, the second bridge circuit and the third bridge circuit are turned on, and the first bridge circuit and the fourth bridge circuit are turned off; during the eighth time interval T8, the second bridge circuit is turned off, and the third bridge circuit and the fourth bridge circuit are not turned on at the same time.

In one embodiment, wherein, during a cycle having time intervals T1, T2, T3, T4, the third bridge circuit is turned on and the second bridge circuit is turned off in the second interval T2; during a cycle having time intervals T1, T2, T7, T8, the second bridge circuit and the third bridge circuit are turned on in the second interval T2; during a cycle having time intervals T5, T6, T7, T8, the second bridge circuit and the third bridge circuit are turned on in the sixth interval T6; and during a cycle having time intervals T5, T6, T3, T4, the third bridge circuit is turned on and the second bridge circuit is turned off in the sixth interval T6.

In one embodiment, wherein, during the cycle having time intervals T1, T2, T3, T4, the first bridge circuit and the fourth bridge circuit are turned on in the fourth interval T4; during the cycle having time intervals T1, T2, T7, T8, the first bridge circuit and the fourth bridge circuit are turned on and the third bridge circuit is turned off in the eighth interval T8; during the cycle having time intervals T5, T6, T7, T8, the first bridge circuit is turned on and the fourth bridge circuit is turned off in the eighth interval T8; and during the cycle having time intervals T5, T6, T3, T4, the first bridge circuit is turned on and the fourth bridge circuit is turned off in the fourth interval T4.

In one embodiment, wherein the first bridge circuit is turned off in the second interval T2, the third bridge circuit is turned off in the eighth interval T8, the first bridge circuit is turned on in the third interval T3, and the third bridge circuit is turned on in the fifth interval T5.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram illustrating a DCDC (Direct Current to Direct Current) double-direction converting device in accordance with some embodiments.

FIG. 2 is a diagram illustrating a first power supply discharging a second power supply in accordance with some embodiments.

FIG. 3 is a diagram illustrating a first power supply discharging a second power supply in accordance with some embodiments.

FIG. 4 is a diagram illustrating a first power supply discharging a second power supply in accordance with some embodiments.

FIG. 5 is a diagram illustrating a second power supply discharging a first power supply Bat in accordance with some embodiments.

FIG. 6 is a diagram illustrating a second power supply discharging a first power supply in accordance with some embodiments.

FIG. 7 is a diagram illustrating a second power supply charging a first power supply in accordance with some embodiments.

FIG. 8 is a diagram illustrating a DCDC double-direction converting device in accordance with some embodiments.

FIG. 9 is a timing diagram illustrating signals in the time intervals T1˜T2 in accordance with some embodiments.

FIG. 10 is a timing diagram illustrating signals in the time intervals T1, T2, T3, and T4 in accordance with some embodiments.

FIG. 11 is a timing diagram illustrating signals in the time intervals T1, T2, T7, and T8 in accordance with some embodiments.

FIG. 12 is a timing diagram illustrating signals in the time intervals T5, T6, T7, and T8 in accordance with some embodiments.

FIG. 13 is a timing diagram illustrating signals in the time intervals T5, T6, T3, and T4 in accordance with some embodiments.

FIG. 14 is a diagram illustrating a DCDC (Direct Current to Direct Current) double-direction converting device in accordance with some embodiments.

FIG. 15 is a diagram illustrating a first power supply discharging a second power supply in accordance with some embodiments.

FIG. 16 is a diagram illustrating a first power supply discharging a second power supply in accordance with some embodiments.

FIG. 17 is a diagram illustrating a first power supply discharging a second power supply in accordance with some embodiments.

FIG. 18 is a diagram illustrating a first power supply charging a second power supply in accordance with some embodiments

FIG. 19 is a diagram illustrating a second power supply discharging a first power supply in accordance with some embodiments.

FIG. 20 is a diagram illustrating a second power supply charging a first power supply in accordance with some embodiments.

FIG. 21 is a diagram illustrating a DCDC double-direction converting device in accordance with some embodiments.

FIG. 22 is a diagram illustrating a DCDC (Direct Current to Direct Current) double-direction converting device in accordance with some embodiments.

FIG. 23 is a diagram illustrating a first power supply discharging a second power supply in accordance with some embodiments.

FIG. 24 is a diagram illustrating a first power supply discharging a second power supply in accordance with some embodiments.

FIG. 25 is a diagram illustrating a first power supply discharging a second power supply in accordance with some embodiments.

FIG. 26 is a diagram illustrating a second power supply charging a first power supply in accordance with some embodiments.

FIG. 27 is a diagram illustrating a second power supply discharging a first power supply in accordance with some embodiments.

FIG. 28 is a diagram illustrating a second power supply charging a first power supply in accordance with some embodiments.

FIG. 29 is a timing diagram illustrating the signals in the time intervals T1˜T2 in accordance with some embodiments.

FIG. 30 is a timing diagram illustrating signals in the time intervals T1, T2, T3, and T4 in accordance with some embodiments.

FIG. 31 is a timing diagram illustrating signals in the time intervals T1, T2, T7, and T8 in accordance with some embodiments.

FIG. 32 is a timing diagram illustrating signals in the time intervals T5, T6, T7, and T8 in accordance with some embodiments.

FIG. 33 is a timing diagram illustrating signals in the time intervals T5, T6 T3, T4 in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one end point to another end point or between two end points. All ranges disclosed herein are inclusive of the end points, unless specified otherwise.

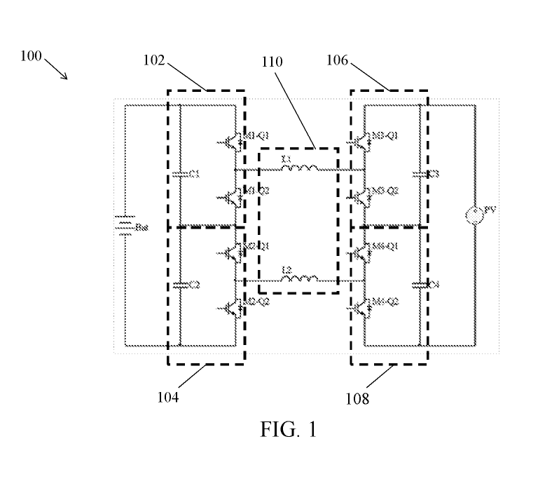

FIG. 1 is a diagram illustrating a DCDC (Direct Current to Direct Current) double-direction converting device 100 in accordance with some embodiments. The DCDC double-direction converting device 100 is a voltage converter capable of generating a higher voltage level according to a lower voltage level or generating a lower voltage level according to a higher voltage level. The DCDC double-direction converting device 100 comprises a first power supply Bat, a first bridge circuit 102, a second bridge circuit 104, a second power supply PV, a third bridge circuit 106, a fourth bridge circuit 108, and an inductive circuit 110. The first power supply Bat has a first positive terminal and a first negative terminal. The first bridge circuit 102 is coupled to the first positive terminal. The second bridge circuit 104 is coupled between the first bridge circuit 102 and the first negative terminal. The second power supply PV has a second positive terminal and a second negative terminal. The third bridge circuit 106 is coupled to the second positive terminal. The fourth bridge circuit 108 is coupled between the third bridge circuit 106 and the second negative terminal. The inductive circuit 110 is coupled between the first bridge circuit 102 and the second bridge circuit 104.

According to some embodiments, the first power supply Bat is a power battery pack and the second power supply PV is a photovoltaic system.

Furthermore, the first bridge circuit 102 comprises a first capacitor C1, a first switching transistor M1-Q1, and a second switching transistor M1-Q2. The first capacitor C1 has a first terminal coupled to the first positive terminal. The first switching transistor M1-Q1 has a first terminal coupled to the first terminal of the first capacitor C1. The second switching transistor M1-Q2 has a first terminal coupled to a second terminal of the first switching transistor M1-Q1, and a second terminal coupled to a second terminal of the first capacitor C1.

The second bridge circuit 104 comprises a second capacitor C2, a third switching transistor M2-Q1, and a fourth switching transistor M2-Q1. The second capacitor C2 has a first terminal coupled to the second terminal of the first capacitor C1, and a second terminal coupled to the first negative terminal of the first power supply Bat. The third switching transistor M2-Q1 has a first terminal coupled to the first terminal of the second capacitor C2. The fourth switching transistor M2-Q2 has a first terminal coupled to a second terminal of the third switching transistor M2-Q1, and a second terminal coupled to the second terminal of the first capacitor C1.

The third bridge circuit 106 comprises a third capacitor C3, a fifth switching transistor M3-Q1, and a sixth switching transistor M3-Q2. The third capacitor C3 has a first terminal coupled to the second positive terminal. The fifth switching transistor M3-Q1 has a first terminal coupled to the first terminal of the third capacitor C3. The sixth switching transistor M3-Q2 has a first terminal coupled to a second terminal of the fifth switching transistor M3-Q1, and a second terminal coupled to a second terminal of the third capacitor C3.

The fourth bridge circuit 108 comprises a fourth capacitor C4, a seventh switching transistor M4-Q1, an eighth switching transistor M4-Q2. The fourth capacitor C4 has a first terminal coupled to the second terminal of the third capacitor C3, and a second terminal coupled to the second negative terminal of the second power supply PV. The seventh switching transistor M4-Q1 has a first terminal coupled to the first terminal of the fourth capacitor C4. The eighth switching transistor M4-Q2 has a first terminal coupled to a second terminal of the seventh switching transistor M4-Q1, and a second terminal coupled to the second terminal of the fourth capacitor C4.

The inductive circuit 110 comprises a first inductor L1 and a second inductor L2. The first inductor L1 has a first terminal coupled to the second terminal of the first switching transistor M1-Q1, and a second terminal coupled to the second terminal of the fifth switching transistor M3-Q1. The second inductor L2 has a first terminal coupled to the second terminal of the third switching transistor M2-Q1, and a second terminal coupled to the second terminal of the seventh switching transistor M4-Q1.

According to some embodiments, the switching transistors M1-Q1, M1-Q2, M2-Q1, M2-Q2, M3-Q1, M3-Q2, M4-Q1, M4-Q2 are N-channel (or P-channel) Insulated Gate Bipolar Transistor (IGBT). However, this is not a limitation of the present invention. The switching transistors M1-Q1, M1-Q2, M2-Q1, M2-Q2, M3-Q1, M3-Q2, M4-Q1, and M4-Q2 may be N-channel (or P-channel) metal-oxide-semiconductor field-effect transistor (MOSFET). Moreover, when the switching transistor M1-Q1, as well as the switching transistors M1-Q2, M2-Q1, M2-Q2, M3-Q1, M3-Q2, M4-Q1, M4-Q2, are N-channel IGBT, the first terminal of the switching transistor M1-Q1 is the collector and the second terminal of the switching transistor M1-Q1 is the emitter. When the switching transistor M1-Q1, as well as the switching transistors M1-Q2, M2-Q1, M2-Q2, M3-Q1, M3-Q2, M4-Q1, M4-Q2, are N-channel MOSFET, the first terminal of the switching transistor M1-Q1 is the drain and the second terminal of the switching transistor M1-Q1 is the source.

In addition, for one bridge circuit (e.g. 102), the switching transistors (e.g. M1-Q1 and M1-Q2) may be implemented as two discrete transistors device or implemented as an integrated transistor having two IGBTs.

According to some embodiments, for the first bridge circuit 102, the emitter of the first switching transistor M1-Q1 is connected to the collector of the second switching transistor M1-Q2 to form a common terminal of the first bridge circuit 102. The capacitor C1 is a polarized capacitor, in which the first terminal of the capacitor C1 is the positive plate (or anode) and the second terminal of the capacitor C1 is the negative plate (or cathode). The positive plate of the capacitor C1 is connected to the collector of the first switching transistor M1-Q1, and the negative plate of the capacitor C1 is connected to the emitter of the second switching transistor M1-Q2.

For the second bridge circuit 104, the emitter of the third switching transistor M2-Q1 is connected to the collector of the fourth switching transistor M2-Q2 to form a common terminal of the second bridge circuit 104. The capacitor C2 is a polarized capacitor, in which the first terminal of the capacitor C2 is the positive plate (or anode) and the second terminal of the capacitor C2 is the negative plate (or cathode). The positive plate of the capacitor C2 is connected to the collector of the third switching transistor M2-Q1, and the negative plate of the capacitor C2 is connected to the emitter of the fourth switching transistor M2-Q2.

For the third bridge circuit 106, the emitter of the fifth switching transistor M3-Q1 is connected to the collector of the sixth switching transistor M3-Q2 to form a common terminal of the third bridge circuit 106. The capacitor C3 is a polarized capacitor, in which the first terminal of the capacitor C3 is the positive plate (or anode) and the second terminal of the capacitor C3 is the negative plate (or cathode). The positive plate of the capacitor C3 is connected to the collector of the fifth switching transistor M3-Q1, and the negative plate of the capacitor C3 is connected to the emitter of the sixth switching transistor M3-Q2.

For the fourth bridge circuit 108, the emitter of the seventh switching transistor M4-Q1 is connected to the collector of the eighth switching transistor M4-Q2 to form a common terminal of the fourth bridge circuit 108. The capacitor C4 is a polarized capacitor, in which the first terminal of the capacitor C4 is the positive plate (or anode) and the second terminal of the capacitor C4 is the negative plate (or cathode). The positive plate of the capacitor C4 is connected to the collector of the seventh switching transistor M4-Q1, and the negative plate of the capacitor C4 is connected to the emitter of the eighth switching transistor M4-Q2.

The first inductor L1 is connected between the common terminal of the first bridge circuit 102 and the common terminal of the third bridge circuit 106. The second inductor L2 is connected between the common terminal of the second bridge circuit 104 and the common terminal of the fourth bridge circuit 108.

It is noted that, the first power supply Bat is a power battery pack and the second power supply PV is a photovoltaic system. However, this is not a limitation of the present invention. In another embodiment, the first power supply Bat may be a photovoltaic system and the second power supply PV may be a power battery pack.

The following paragraphs describes the operation of the DCDC double-direction converting device 100. According to some embodiments, the DCDC double-direction converting device 100 is configured to have four operating modes, i.e. two Boost modes and two Buck modes. However, this is not a limitation of the present invention.

1. The first Boost mode, i.e. the first power supply Bat (i.e. the power battery pack) discharges the second power supply PV (i.e. the photovoltaic system):

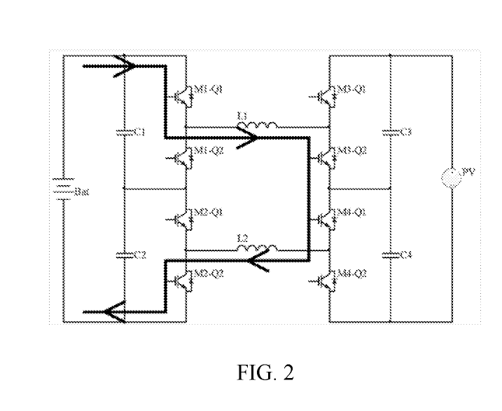

FIG. 2 is a diagram illustrating the first power supply Bat discharging the second power supply PV in accordance with some embodiments. FIG. 2 shows an equivalent model of storing energy in a Boost mode.

During the storing energy, the switching transistors M1-Q1, M3-Q2, M4-Q1, and M2-Q2 are turned on. As shown in FIG. 2, the current flows from the positive terminal (i.e. the first terminal of capacitor C1) of the first power supply Bat to the negative terminal (i.e. the second terminal of capacitor C2) of the first power supply Bat through the switching transistor M1-Q1, the first inductor L1, the switching transistor M3-Q2, the switching transistor M4-Q1, the second inductor L2, and the switching transistor M2-Q2. During the process, the energy of the capacitor C1 and capacitor C2 is discharged, and the energy of the first inductor L1 and the second inductor L2 is charged or stored. As the capacitor C1 and the capacitor C2 are serially connected between the positive terminal of the first power supply Bat and the negative terminal of the first power supply Bat, the discharging of the capacitor C1 and the capacitor C2 means that the energy of the first power supply Bat also discharges.

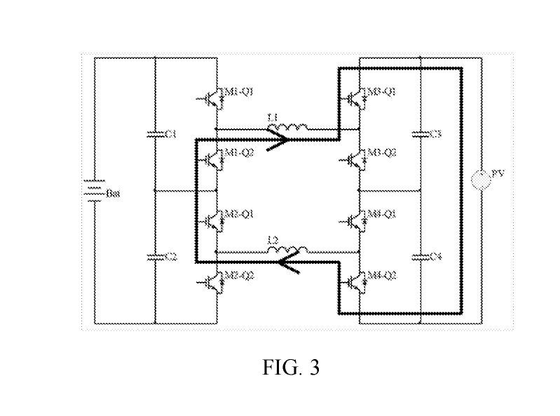

FIG. 3 is a diagram illustrating the first power supply Bat discharging the second power supply PV in accordance with some embodiments. FIG. 3 shows an equivalent model of current flyback in a Boost mode.

During the flyback, the switching transistors M1-Q1, M3-Q2, M4-Q1, and M2-Q2 are turned off. As shown in FIG. 3, the current flows from the first terminal of the first inductor L1 to the second terminal of the first inductor L1 through the body diode of the switching transistor M3-Q1, the capacitor C3 (i.e. the positive terminal of the photovoltaic system), the capacitor C4 (i.e. the negative terminal of the photovoltaic system), the body diode of the switching transistor M4-Q2, the second inductor L2, the body diode of the switching transistor M2-Q1, and the body diode of the switching transistor M1-Q2. During the process, the energy of the first inductor L1 and the second inductor L2 is released or discharged, and the energy of the capacitor C3 and the capacitor C4 is charged. As the capacitor C3 and the capacitor C4 are serially connected between the positive terminal of the second power supply PV and the negative terminal of the second power supply PV, the charging of the capacitor C3 and the capacitor C4 means that the energy of the second power supply PV also charges.

Accordingly, the equivalent models of FIG. 2 and FIG. 3 are capable of discharging current to the capacitor C3 and the capacitor C4 from the capacitor C1 and the capacitor C2. Accordingly, the first power supply Bat may discharge current to the second power supply PV during the first Boost mode, i.e. the voltage up-converting mode.

2. The first Buck mode, i.e. the first power supply Bat (i.e. the power battery pack) discharges the second power supply PV (i.e. the photovoltaic system):

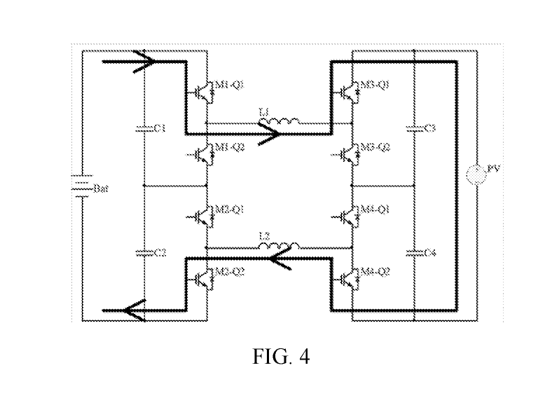

FIG. 4 is a diagram illustrating the first power supply Bat discharging the second power supply PV in accordance with some embodiments. FIG. 4 shows an equivalent model of storing energy in a Buck mode.

During the storing energy, the switching transistors M1-Q1 and M2-Q2 are turned on, and the switching transistors M3-Q2 and M4-Q1 are turned off. As shown in FIG. 4, the current flows from the positive terminal (i.e. the first terminal of capacitor C1) of the first power supply Bat to the negative terminal (i.e. the second terminal of capacitor C2) of the first power supply Bat through the switching transistor M1-Q1, the first inductor L1, the body diode of the switching transistor M3-Q1, the capacitor C3 (i.e. the positive terminal of the photovoltaic system), the capacitor C4 (i.e. the negative terminal of the photovoltaic system), the body diode of the switching transistor M4-Q2, the second inductor L2, and the switching transistor M2-Q2. During the process, the energy of the capacitor C1 and capacitor C2 is discharged, the energy of the capacitor C3 and capacitor C4 is charged, and the energy of the first inductor L1 and the second inductor L2 is charged or stored. As the capacitor C1 and the capacitor C2 are serially connected between the positive terminal of the first power supply Bat and the negative terminal of the first power supply Bat, the discharging of the capacitor C1 and the capacitor C2 means that the energy of the first power supply Bat also discharges. As the capacitor C3 and the capacitor C4 are serially connected between the positive terminal of the second power supply PV and the negative terminal of the second power supply PV, the charging of the capacitor C3 and the capacitor C4 means that the energy of the second power supply PV also charges.

As shown in FIG. 3, the first power supply Bat may also discharge the second power supply PV based on the operation in the following paragraph, which is an equivalent model of current flyback in a Buck mode.

During the flyback, the switching transistors M1-Q1, M3-Q2, M4-Q1, and M2-Q2 are turned off. As shown in FIG. 3, the current flows from the first terminal of the first inductor L1 to the second terminal of the first inductor L1 through the body diode of the switching transistor M3-Q1, the capacitor C3 (i.e. the positive terminal of the photovoltaic system), the capacitor C4 (i.e. the negative terminal of the photovoltaic system), the body diode of the switching transistor M4-Q2, the second inductor L2, the body diode of the switching transistor M2-Q1, and the body diode of the switching transistor M1-Q2. During the process, the energy of the first inductor L1 and the second inductor L2 is released or discharged, and the energy of the capacitor C3 and the capacitor C4 is charged. As the capacitor C3 and the capacitor C4 are serially connected between the positive terminal of the second power supply PV and the negative terminal of the second power supply PV, the charging of the capacitor C3 and the capacitor C4 means that the energy of the second power supply PV also charges.

Accordingly, the equivalent models of FIG. 3 and FIG. 4 are capable of discharging current to the capacitor C3 and the capacitor C4 from the capacitor C1 and the capacitor C2. Accordingly, the first power supply Bat may discharge current to the second power supply PV during the first Buck mode, i.e. the voltage down-converting mode.

3. The second Boost mode, i.e. the second power supply PV (i.e. the photovoltaic system) discharges the first power supply Bat (i.e. the power battery pack):

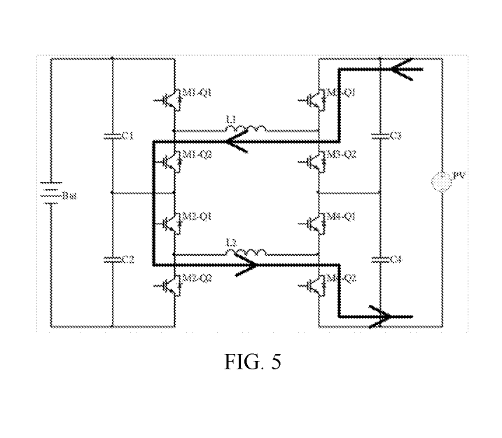

FIG. 5 is a diagram illustrating the second power supply PV discharging the first power supply Bat in accordance with some embodiments. FIG. 2 shows an equivalent model of storing energy in a Boost mode.

During the storing energy, the switching transistors M3-Q1, M1-Q2, M2-Q1, and M4-Q2 are turned on. As shown in FIG. 5, the current flows from the capacitor C3 (i.e. the positive terminal of the second power supply PV) to the capacitor C4 (i.e. the negative terminal of the second power supply PV) through the switching transistor M3-Q1, the first inductor L1, the switching transistor M1-Q2, the switching transistor M2-Q1, the second inductor L2, and the switching transistor M4-Q2. During the process, the energy of the capacitor C3 and capacitor C4 is discharged, and the energy of the first inductor L1 and the second inductor L2 is charged or stored. As the capacitor C3 and the capacitor C4 are serially connected between the positive terminal of the second power supply PV and the negative terminal of the second power supply PV, the discharging of the capacitor C3 and the capacitor C4 means that the energy of the second power supply PV also discharges.

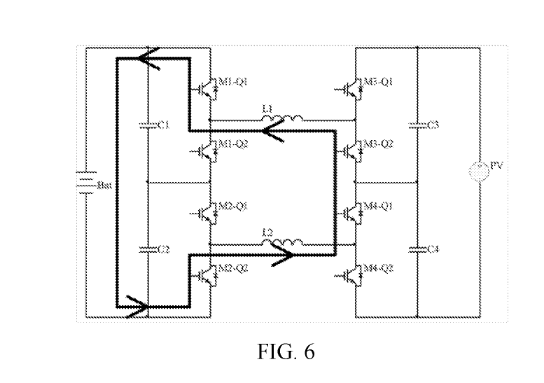

FIG. 6 is a diagram illustrating the second power supply PV discharging the first power supply Bat in accordance with some embodiments. FIG. 6 shows an equivalent model of current flyback in a Boost mode.

During the flyback, the switching transistors M3-Q1, M1-Q2, M2-Q1, and M4-Q2 are turned off. As shown in FIG. 6, the current flows from the first terminal of the first inductor L1 to the second terminal of the first inductor L1 through the body diode of the switching transistor M1-Q1, the capacitor C1 (i.e. the positive terminal of the first power supply Bat), the capacitor C2 (i.e. the negative terminal of the first power supply Bat), the body diode of the switching transistor M2-Q2, the second inductor L2, the body diode of the switching transistor M4-Q1, and the body diode of the switching transistor M3-Q2. During the process, the energy of the first inductor L1 and the second inductor L2 is released or discharged, and the energy of the capacitor C1 and the capacitor C2 is charged. As the capacitor C1 and the capacitor C2 are serially connected between the positive terminal of the first power supply Bat and the negative terminal of the first power supply Bat, the charging of the capacitor C1 and the capacitor C2 means that the energy of the first power supply Bat also charges.

Accordingly, the equivalent models of FIG. 5 and FIG. 6 are capable of charging current to the capacitor C1 and the capacitor C2 from the capacitor C3 and the capacitor C4. Accordingly, the second power supply PV may charge current to the first power supply Bat during the second Boost mode, i.e. the voltage up-converting mode.

4. The second Buck mode, i.e. the second power supply PV (i.e. the photovoltaic system) discharges the first power supply Bat (i.e. the power battery pack):

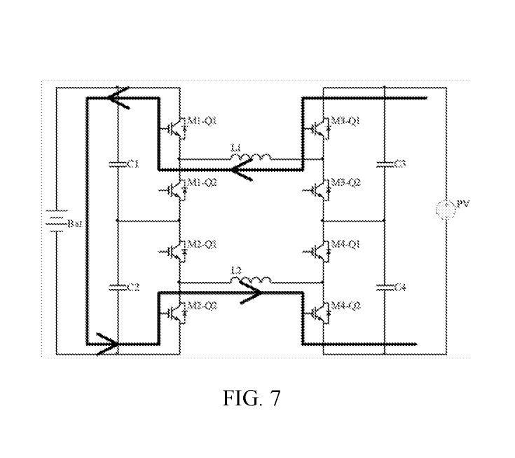

FIG. 7 is a diagram illustrating the second power supply PV charging the first power supply Bat in accordance with some embodiments. FIG. 7 shows an equivalent model of storing energy in a Buck mode.

During the storing energy, the switching transistors M3-Q1 and M4-Q2 are turned on, and the switching transistors M1-Q2 and M2-Q1 are turned off. As shown in FIG. 7, the current flows from the positive terminal (i.e. capacitor C3) of the second power supply PV to the negative terminal (i.e. the capacitor C4) of the second power supply PV through the switching transistor M3-Q1, the first inductor L1, the body diode of the switching transistor M1-Q1, the capacitor C1 (i.e. the positive terminal of the first power supply Bat), the capacitor C2 (i.e. the negative terminal of the first power supply Bat), the body diode of the switching transistor M2-Q2, the second inductor L2, and the switching transistor M4-Q2. During the process, the energy of the capacitor C3 and capacitor C4 is discharged, the energy of the capacitor C1 and capacitor C1 is charged, and the energy of the first inductor L1 and the second inductor L2 is charged or stored. As the capacitor C1 and the capacitor C2 are serially connected between the positive terminal of the first power supply Bat and the negative terminal of the first power supply Bat, the charging of the capacitor C1 and the capacitor C2 means that the energy of the first power supply Bat also discharges. As the capacitor C3 and the capacitor C4 are serially connected between the positive terminal of the second power supply PV and the negative terminal of the second power supply PV, the discharging of the capacitor C3 and the capacitor C4 means that the energy of the second power supply PV also discharges.

As shown in FIG. 6, the second power supply PV may also charge the first power supply Bat based on the operation in the following paragraph, which is an equivalent model of current flyback in a Buck mode.

During the flyback, the switching transistors M3-Q1, M1-Q2, M2-Q1, and M4-Q2 are turned off. As shown in FIG. 6, the current flows from the first terminal of the first inductor L1 to the second terminal of the first inductor L1 through the body diode of the switching transistor M1-Q1, the capacitor C1 (i.e. the positive terminal of the first power supply Bat), the capacitor C2 (i.e. the negative terminal of the first power supply Bat), the body diode of the switching transistor M2-Q2, the second inductor L2, the body diode of the switching transistor M4-Q1, and the body diode of the switching transistor M3-Q2. During the process, the energy of the first inductor L1 and the second inductor L2 is released or discharged, and the energy of the capacitor C1 and the capacitor C2 is charged. As the capacitor C1 and the capacitor C2 are serially connected between the positive terminal of the first power supply Bat and the negative terminal of the first power supply Bat, the charging of the capacitor C1 and the capacitor C2 means that the energy of the second power supply PV also charges.

Accordingly, the equivalent models of FIG. 6 and FIG. 7 are capable of discharging current to the capacitor C3 and the capacitor C4 from the capacitor C1 and the capacitor C2. Accordingly, the second power supply PV may discharge current to the first power supply Ba during the second Buck mode, i.e. the voltage down-converting mode.

The DCDC double-direction converting device 100 is controlled to turn on or turn off the first bridge circuit 102, the second bridge circuit 104, the third bridge circuit 104, and the fourth bridge circuit 108 to provide an up-convert or down-convert voltage level. In comparison to the related art, the DCDC double-direction converting device 100 is capable of selectively switching between the Buck mode and the Boost mode. The DCDC double-direction converting device 100 is also configured to have double direction depending on the charging or discharging of the first power supply Bat (or the second power supply PV). Accordingly, the DCDC double-direction converting device 100 may be applied in different application fields, such as the high voltage field.

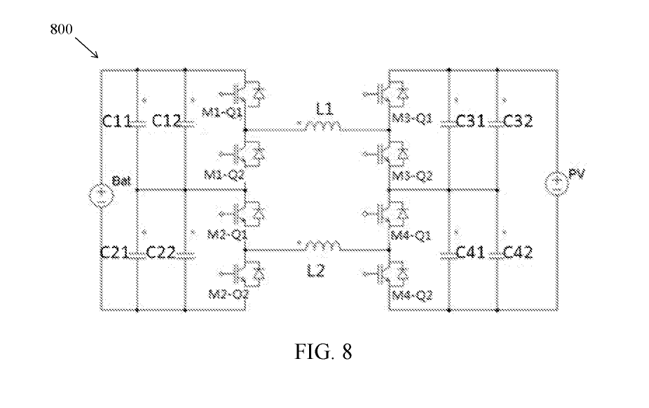

FIG. 8 is a diagram illustrating a DCDC double-direction converting device 800 in accordance with some embodiments. In comparison to the DCDC double-direction converting device 100 of FIG. 1, the DCDC double-direction converting device 800 comprises more capacitors in the bridge circuits.

In FIG. 8, the first capacitor C1 of the DCDC double-direction converting device 100 is replaced with two capacitors C11, C12 connected in parallel. The second capacitor C2 of the DCDC double-direction converting device 100 is replaced with two capacitors C21, C22 connected in parallel. The third capacitor C3 of the DCDC double-direction converting device 100 is replaced with two capacitors C31, C32 connected in parallel. The fourth capacitor C4 of the DCDC double-direction converting device 100 is replaced with two capacitors C41, C42 connected in parallel. The operation and benefit of the DCDC double-direction converting device 800 is similar to the DCDC double-direction converting device 100, thus the detailed description is omitted here for brevity.

Moreover, according to some embodiments, the capacitance of the capacitor C1 is equal to the capacitance of the capacitor C2, and the capacitance of the capacitor C3 is equal to the capacitance of the capacitor C4.

According to some embodiments, the DCDC double-direction converting device 100 may be operated in the following four modes:

1. When the voltage level of the first power supply Bat is lower than the voltage level of the second power supply PV, the first power supply Bat discharges current to the second power supply PV.

2. When the voltage level of the first power supply Bat is higher than the voltage level of the second power supply PV, the first power supply Bat discharges current to the second power supply PV.

3. When the voltage level of the first power supply Bat is lower than the voltage level of the second power supply PV, the second power supply PV discharges current to the first power supply Bat.

4. When the voltage level of the first power supply Bat is higher than the voltage level of the second power supply PV, the second power supply PV discharges current to the first power supply Bat.

The above mentioned four controlling methods of the DCDC double-direction converting device 100 is described in detail in the following paragraphs and diagrams.

1. When the voltage level of the first power supply Bat is lower than the voltage level of the second power supply PV, the first power supply Bat discharges current to the second power supply PV, and the controlling method is as followed:

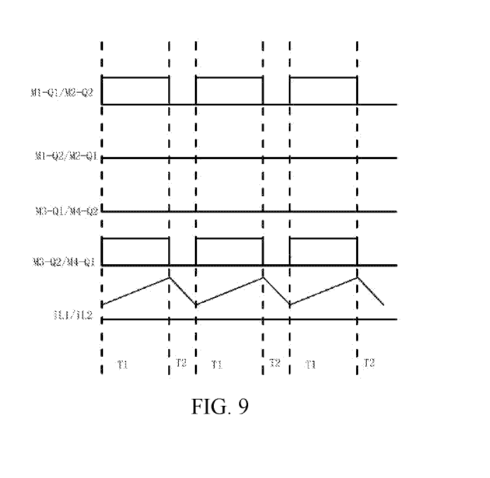

When the first power supply Bat is arranged to discharge current to the second power supply PV, and when the voltage level of the first power supply Bat is lower than the voltage level of the second power supply PV, the DCDC double-direction converting device 100 is controlled to operate in a switching cycle having a first time interval T1 and a second time interval T2, wherein the first time interval T1 and the second time interval T2 are two consecutive time intervals, and the first time interval T1 is followed by the second time interval T2. During T2, detecting if the current of the first inductor L1 and/or the current of the second inductor L2 crosses the zero current, if yes, controlling the DCDC double-direction converting device 100 to operate in the time intervals T3, T4, or the time intervals T7, T8 after time interval T2. FIG. 9 is a timing diagram illustrating the signals in the time intervals T1˜T2 in accordance with some embodiments.

During the time interval T1, the switching transistors M1-Q1, M3-Q2, M2-Q2, and M4-Q1 are turned on, the switching transistors M1-Q2, M3-Q1, M2-Q1, and M4-Q2 are turned off. The current flow during the time interval T1 has been shown in FIG. 2, and the detailed description is omitted here for brevity. When the current of the first inductor L1 flows to the bridge circuit 106 from the bridge circuit 102, the current is defined as “positive” current. When the current of the second inductor L2 flows to the bridge circuit 104 from the bridge circuit 108, the current is defined as “negative” current. During the time interval T1, the current of the first inductor L1 and the current of the second inductor L2 are positive current, and the currents gradually increase. Accordingly, the first inductor L1 and the second inductor L2 store energy until the time interval T2.

During the time interval T2, the switching transistors M3-Q2 and M4-Q1 are turned off, the switching transistors M1-Q1 and M1-Q2 are not turned on at the same time, the switching transistors M2-Q1 and M2-Q2 are not turned on at the same time. During the time interval T2, the currents may have two directions.

The first current direction is happened when the switching transistors M1-Q1 and M2-Q2 are turned on, and the switching transistors M1-Q2 and M2-Q1 are turned off. In this process, the energy of the inductor L1 is released. The current flow of this process has been shown in FIG. 4, and the detailed description is omitted here for brevity.

The second current direction is happened when the switching transistors M1-Q1, M1-Q2, M2-Q1, and M2-Q2 are turned off. In this process, the energy of the inductor L1 is released. The current flow of this process has been shown in FIG. 3, and the detailed description is omitted here for brevity.

In the above mentioned first current direction and the second current direction, the energy of the inductors L1 and L2 is released, the currents are positive current, and the currents gradually decrease. Meanwhile, the capacitors C3 and C4 are charged by currents. As the capacitor C3 and the capacitor C4 are serially connected between the positive terminal of the second power supply PV and the negative terminal of the second power supply PV, the charging of the capacitor C3 and the capacitor C4 means that the energy of the second power supply PV also charges.

During the time interval T2, when the switching transistors M1-Q1 and M2-Q2 are turned off, the current flows through the body diode of the switching transistors M2-Q1 and the body diode of the switching transistors M1-Q2. During the time interval T1, the current flows through the switching transistors M1-Q1 and M2-Q2. Accordingly, during the time intervals T1 and T2, the currents flow through different switching transistors respectively. Therefore, the DCDC double-direction converting device 100 may have better heat dissipation effect. According to some embodiments, the second current direction may be the better option in the time interval T2.

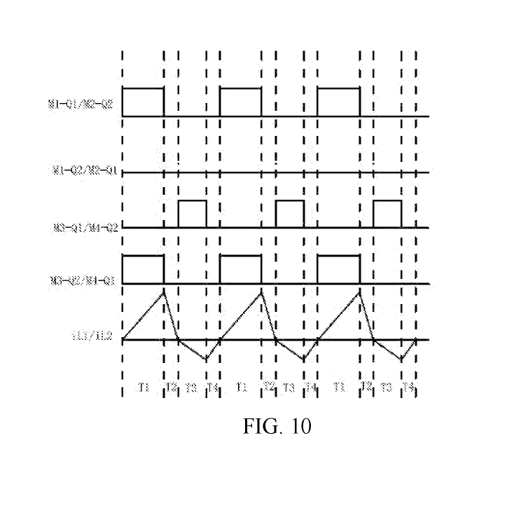

Moreover, during the time intervals T1 and T2, the first power supply Bat is arranged to boost the voltage level of the second power supply PV. The switching transistor M3-Q2 and M4-Q1 may be regarded as the high frequency transistors of the Boost circuit. When the switching transistor M3-Q2 and M4-Q1 have greater duty cycle (i.e. when T1 is greater than T2), the current of the first inductor L1 and the current of the second inductor L2 are continuous, and the currents are positive current. As shown in FIG. 9, when the duty cycle decreases to reach a specific value, the inductor current reaches the zero when the cycle is finished, and the next cycle begins at the same time. Then, the inductors may store energy again, and the inductor currents increase, i.e. the threshold current mode. When the duty cycle is further reduced, i.e. the inductor currents reach zero in the time interval T2, and the cycle is not finished yet, the DCDC double-direction converting device 100 may enter the time intervals T3 and T4 or T7 and T8. FIG. 10 is a timing diagram illustrating the signals in the time intervals T1, T2, T3, and T4 in accordance with some embodiments.

During the time interval T3, the switching transistors M3-Q1 and M4-Q2 are turned on, the switching transistors M1-Q2, M2-Q1, M3-Q2, M4-Q1 are turned off. The current flow of this process has been shown in FIG. 7, and the detailed description is omitted here for brevity.

In this process, the capacitors C3 and C4 are discharged, and the capacitors C1 and C2 are charged. The energy of inductors L1 and L2 is stored, and the currents increase. However, the inductor currents are negative current. As the capacitor C1 and the capacitor C2 are serially connected between the positive terminal of the first power supply Bat and the negative terminal of the first power supply Bat, the charging of the capacitor C1 and the capacitor C2 means that the energy of the first power supply Bat also charges. As the capacitor C3 and the capacitor C4 are serially connected between the positive terminal of the second power supply PV and the negative terminal of the second power supply PV, the discharging of the capacitor C3 and the capacitor C4 means that the energy of the second power supply PV also discharges.

During the time interval T4, the switching transistors M3-Q1, M1-Q2, M2-Q1, and M4-Q2 are turned off. The energy of the inductor L1 is released. The current flow of this process has been shown in FIG. 6, and the detailed description is omitted here for brevity. In this process, the energy of the inductors L1 and L2 is released, the currents are negative current, and the currents gradually decrease. Meanwhile, the capacitors C1 and C2 are charged by currents. As the capacitor C1 and the capacitor C2 are serially connected between the positive terminal of the first power supply Bat and the negative terminal of the first power supply Bat, the charging of the capacitor C1 and the capacitor C2 means that the energy of the first power supply Bat also charges.

According to the time intervals T1˜T4, during the switching cycles, the currents of the inductors are continuous. In one cycle, if the first power supply Bat is arranged to discharge current to the second power supply PV, then the area formed by the positive current of the first inductor L1 and/or the positive current of the second inductor L2 may be designed to be greater than the area formed by the negative current of the first inductor L1 and/or the negative current of the second inductor L2. The different value of the two areas may be the discharging energy from the first power supply Bat to the second power supply PV.

Furthermore, when the voltage level of the first power supply Bat is lower than the voltage level of the second power supply PV, the DCDC double-direction converting device 100 is arranged to operate in the time interval T3 before the currents of the inductors L1 and/or L2 cross the zero current. Specifically, during the time interval T2, the switching transistors M3-Q1 and M4-Q2 are turned on, and the switching transistors M1-Q2 and M2-Q1 are turned off. Meanwhile, the current of the inductor L1 or L2 is positive current, and the current flows through the body diode of the switching transistor M3-Q1 or the body diode of the switching transistor M4-Q2 to form a loop. As shown in FIG. 3 and FIG. 4, the direction of the current is similar to the current direction in the time interval T2. When the current of the inductor L1 or L2 reaches zero, the next time interval T3 may start immediately to avoid the switching discontinuity when the time interval T2 proceeds to the next time interval T3.

Furthermore, during the time interval T4, the switching transistors M1-Q1, M3-Q2, M2-Q2, and M4-Q1 are turned on. Meanwhile, the current of the inductor L1 or L2 is negative current, the direction of the current is similar to the current direction in the time interval T4. As shown in FIG. 6, when the current of the inductor L1 or L2 reaches zero, the time interval T1 in the next cycle may start immediately to avoid the switching discontinuity when the time interval T4 proceeds to the next time interval T1.

In addition, during the time intervals T2 and T3, the switching transistors M1-Q1 and M2-Q2 are turned off. According to the time intervals T1˜T4, the switching transistors M1-Q2 and M2-Q1 are turned off in the whole switching cycle; the switching transistors M1-Q1, M3-Q2, M2-Q2, and M4-Q1 are controlled by the first control signal; the switching transistors M3-Q1 and M4-Q2 are controlled by the second control signal. To reduce the circuit complexity and to extend the lifetime of transistors, the second control signal may be the voltage inverted from the first control signal.

In another embodiment, during the time intervals T2 and T3, the switching transistors M1-Q1 and M2-Q2 are turned on. According to the time intervals T1˜T4, the switching transistors M1-Q1 and M2-Q2 are turned on in the whole switching cycle, the switching transistors M1-Q2 and M2-Q1 are turned off in the whole switching cycle; the switching transistors M3-Q2 and M4-Q1 are controlled by the first control signal; the switching transistors M3-Q1 and M4-Q2 are controlled by the second control signal. To reduce the circuit complexity and to extend the lifetime of transistors, the second control signal may be the voltage inverted from the first control signal.

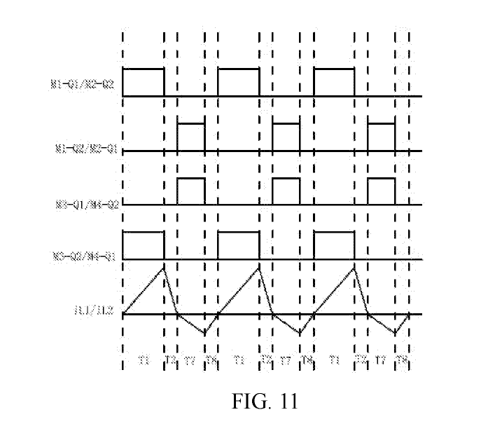

After the time intervals T1, T2, the DCDC double-direction converting device 100 may be operated in the time intervals T7, T8. FIG. 11 is a timing diagram illustrating the signals in the time intervals T1, T2, T7, and T8 in accordance with some embodiments.

During the time interval T7, the switching transistors M3-Q1, M1-Q2, M2-Q1, and M4-Q2 are turned on, the switching transistors M1-Q1 and M4-Q1 are turned off. The current flow of this process has been shown in FIG. 5, and the detailed description is omitted here for brevity. In this process, the capacitors C3 and C4 are discharged, and the inductors L1 and L2 are energy stored, and the currents increase. However, the inductor currents are negative current. As the capacitor C3 and the capacitor C4 are serially connected between the positive terminal of the second power supply PV and the negative terminal of the second power supply PV, the discharging of the capacitor C3 and the capacitor C4 means that the energy of the second power supply PV also discharges.

During the time interval T8, the switching transistors M1-Q2 and M2-Q1 are turned off, the switching transistors M3-Q1 and M3-Q2 are not turned on at the same time, the switching transistors M4-Q1 and M4-Q2 are not turned on at the same time. During the time interval T8, the currents may have two directions.

The first current direction is happened when the switching transistors M3-Q1 and M4-Q2 are turned on, and the switching transistors M3-Q2 and M4-Q1 are turned off as shown in FIG. 7. In this process, the energy of the inductor L1 is released. The current flow of this process has been shown in FIG. 7, and the detailed description is omitted here for brevity. In this process, the capacitors C3 and C4 are discharged, the capacitors C1 and C2 are charged, the inductors L1 and L2 are energy stored, and the currents increase. However, the inductor currents are negative current. As the capacitor C1 and the capacitor C2 are serially connected between the positive terminal of the first power supply Bat and the negative terminal of the first power supply Bat, the charging of the capacitor C1 and the capacitor C2 means that the energy of the first power supply Bat also charges. As the capacitor C3 and the capacitor C4 are serially connected between the positive terminal of the second power supply PV and the negative terminal of the second power supply PV, the discharging of the capacitor C3 and the capacitor C4 means that the energy of the second power supply PV also discharges.

The second current direction is happened when the switching transistors M3-Q1 and M4-Q2 are turned off. In this process, the energy of the inductor L1 is released. The current flow of this process has been shown in FIG. 6, and the detailed description is omitted here for brevity. In this process, the inductors L1 and L2 are energy released, the capacitors C1 and C2 are charged. As the capacitor C1 and the capacitor C2 are serially connected between the positive terminal of the first power supply Bat and the negative terminal of the first power supply Bat, the charging of the capacitor C1 and the capacitor C2 means that the energy of the first power supply Bat also charges.

In the above mentioned first current direction and the second current direction, the energy of the inductors L1 and L2 is released, the currents are negative current, and the currents gradually decrease.

During the time interval T8, the switching transistors M3-Q1 and M4-Q2 are turned off such that the current flows through the body diodes of the switching transistors M3-Q2 and M4-Q1. During the time interval T7, the current flows through the switching transistors M3-Q1 and M4-Q2. When the time intervals T7 and T8 are combined, the currents flow through different switching transistors respectively. Therefore, the DCDC double-direction converting device 100 may have better heat dissipation effect. According to some embodiments, the second current direction may be the better option in the time interval T8.

According to the time intervals T1, T2, T7, T8, during the switching cycles, the currents of the inductors are continuous.

Furthermore, the DCDC double-direction converting device 100 is arranged to operate in the time interval T7 before the currents of the inductors L1 and/or L2 cross the zero current. Specifically, during the time interval T2, the switching transistors M1-Q2, M3-Q1, M2-Q1, and M4-Q2 are turned on, and the switching transistors M1-Q1 and M2-Q2 are turned off. Meanwhile, when the current of the inductor L1 or L2 is positive current, the direction of the current is similar to the current direction in the time interval T2 as shown in FIG. 3 and FIG. 4. When the current of the inductor L1 or L2 reaches zero, the time interval T7 may start immediately to avoid the switching discontinuity when the time interval T2 proceeds to the next time interval T7.

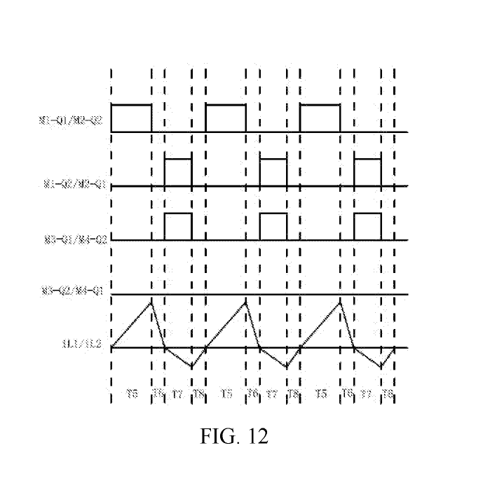

Furthermore, during the time interval T8, the switching transistors M1-Q1, M3-Q2, M2-Q2, and M4-Q1 are turned on, and the switching transistors M3-Q1 and M4-Q2 are turned off. Meanwhile, when the current of the inductor L1 or L2 is negative current, the direction of the current is similar to the current direction in the time interval T8 as shown in FIG. 11 or FIG. 12. FIG. 11 is a timing diagram illustrating the signals in the time intervals T1, T2, T7, and T8 in accordance with some embodiments. FIG. 12 is a timing diagram illustrating the signals in the time intervals T5, T6, T7, and T8 in accordance with some embodiments. When the current of the inductor L1 or L2 reaches zero, the time interval T1 in the next cycle may start immediately to avoid the switching discontinuity when the time interval T8 proceeds to the next time interval T1.

According to the time intervals T1, T2, T3, and T4, the switching transistors M1-Q1, M3-Q2, M2-Q2, and M4-Q1 are controlled by the first control signal; the switching transistors M1-Q2, M3-Q1, M2-Q1, and M4-Q2 are controlled by the second control signal. To reduce the circuit complexity and to extend the lifetime of transistors, the second control signal may be the voltage inverted from the first control signal.

2. When the voltage level of the first power supply Bat is higher than the voltage level of the second power supply PV, the first power supply Bat is arranged to discharge current to the second power supply PV according to the following method:

When the first power supply Bat is arranged to discharge current to the second power supply PV, and when the voltage level of the first power supply Bat is higher than the voltage level of the second power supply PV, the DCDC double-direction converting device 100 is controlled to operate in a switching cycle having the time interval T5 and the time interval T6, wherein the time interval T5 and the time interval T6 are two consecutive time intervals, and the time interval T5 is followed by the time interval T6. During T6, detecting if the current of the first inductor L1 and/or the current of the second inductor L2 crosses the zero current, if yes, controlling the DCDC double-direction converting device 100 to operate in the time intervals T7, T8, or the time intervals T3, T4 after time interval T6. After the time intervals T5, T6, the DCDC double-direction converting device 100 may be controlled to operate in the time intervals T7, T8 as shown in FIG. 12.

During the time interval T5, the switching transistors M1-Q1 and M2-Q2 are turned on, and the switching transistors M1-Q2, M3-Q2, M4-Q1, and M2-Q1 are turned off. The current flow during the time interval T5 has been shown in FIG. 4, and the detailed description is omitted here for brevity. In this process, the capacitors C1, C2, C3, and C4 are charged, and the inductors L1 and L2 are energy stored. As the capacitor C1 and the capacitor C2 are serially connected between the positive terminal of the first power supply Bat and the negative terminal of the first power supply Bat, the discharging of the capacitor C1 and the capacitor C2 means that the energy of the first power supply Bat also discharges. As the capacitor C3 and the capacitor C4 are serially connected between the positive terminal of the second power supply PV and the negative terminal of the second power supply PV, the charging of the capacitor C3 and the capacitor C4 means that the energy of the second power supply PV also discharges. In this process, the currents of the inductors L1 and L2 are positive current, the currents gradually increase, and the energy of the inductors L1 and L2 is stored until the time interval T6.

During the time interval T6, the switching transistors M1-Q1, M3-Q2, M4-Q1, and M2-Q2 are turned off. The energy of the inductors L1 is released. The current flow during the time interval T6 has been shown in FIG. 3, and the detailed description is omitted here for brevity. In this process, the inductors L1 and L2 are energy released, the currents of the inductors L1 and L2 are positive current, and the currents gradually decrease.

During the time intervals T5, T6, the first power supply Bat is arranged to generate the reduced voltage level to the second power supply PV. The switching transistor M1-Q1 and M2-Q2 may be regarded as the high frequency transistors of the Buck circuit. When the switching transistor M1-Q1 and M2-Q2 have greater duty cycle (i.e. when T5 is greater than T6), the current of the first inductor L1 and the current of the second inductor L2 are continuous, and the currents are positive current. When the duty cycle decreases to reach a specific value, the inductor current reaches the zero when the cycle finishes, and the next cycle begins at the same time. Then, the inductors may store energy again, and the inductor currents increase, i.e. the threshold current mode. When the duty cycle is further reduced, i.e. the inductor currents reach zero in the time interval T6, and the cycle is not finished yet, the DCDC double-direction converting device 100 may enter the time intervals T7 and T8 as shown in FIG. 12.

The time intervals T7 and T8 has been described, and the detailed description is omitted here for brevity.

According to the time intervals T5˜T8, during the switching cycles, the currents of the inductors are continuous.

Furthermore, when the voltage level of the first power supply Bat is higher than the voltage level of the second power supply PV, the DCDC double-direction converting device 100 is arranged to operate in the time interval T7 before the currents of the inductors L1 and/or L2 cross the zero current. Specifically, during the time interval T6, the switching transistors M1-Q2, M3-Q1, M2-Q1, and M4-Q2 are turned on. Meanwhile, the current of the inductor L1 or L2 is positive current, the direction of the current is similar to the current direction in the time interval T6 as shown in FIG. 3. When the current of the inductor L1 or L2 reaches zero, the time interval T7 may start immediately to avoid the switching discontinuity when the time interval T6 proceeds to the next time interval T7.

Furthermore, during the time interval T8, the switching transistors M1-Q1 and M2-Q2 are turned on, and the switching transistors M3-Q2 and M4-Q1 are turned off. Meanwhile, the current of the inductor L1 or L2 is negative current, the direction of the current is similar to the current direction in the time interval T8. As shown in FIG. 6 or FIG. 7, when the current of the inductor L1 or L2 reaches zero, the time interval T5 in the next cycle may start immediately to avoid the switching discontinuity when the time interval T8 proceeds to the next time interval T5.

In addition, during the time intervals T5 and T8, the switching transistors M3-Q1 and M4-Q2 are turned off. According to the time intervals T5˜T8, the switching transistors M3-Q2 and M4-Q1 are turned off in the whole switching cycle; the switching transistors M1-Q1 and M2-Q2 are controlled by the first control signal; the switching transistors M1-Q2, M3-Q1, M2-Q1, and M4-Q2 are controlled by the second control signal. To reduce the circuit complexity and to extend the lifetime of transistors, the second control signal may be the voltage inverted from the first control signal.

In another embodiment, during the time intervals T5 and T8, the switching transistors M3-Q1 and M4-Q2 are turned on. According to the time intervals T5˜T8, the switching transistors M3-Q1 and M4-Q2 are turned on in the whole switching cycle, the switching transistors M2-Q2 and M4-Q1 are turned off in the whole switching cycle; the switching transistors M1-Q2 and M2-Q2 are controlled by the first control signal; the switching transistors M1-Q2 and M2-Q1 are controlled by the second control signal. To reduce the circuit complexity and to extend the lifetime of transistors, the second control signal may be the voltage inverted from the first control signal.

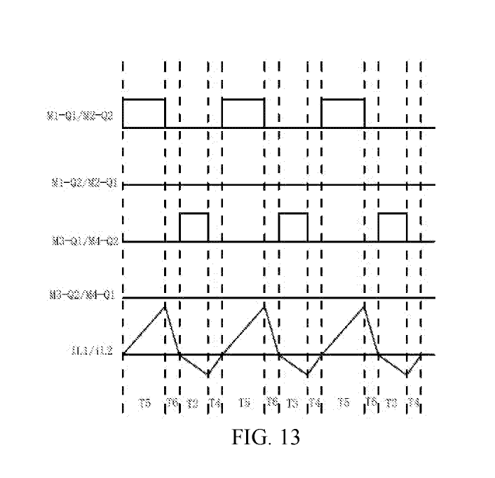

After the time intervals T5 and T6, the DCDC double-direction converting device 100 may be operated in the time intervals T3 and T4. FIG. 13 is a timing diagram illustrating the signals in the time intervals T5, T6, T3, and T4 in accordance with some embodiments. The current direction of the currents in the time intervals T5, T6, T3, and T4 are shown in FIG. 13, the detailed description is omitted here for brevity.

Furthermore, when the voltage level of the first power supply Bat is higher than the voltage level of the second power supply PV, the DCDC double-direction converting device 100 is arranged to operate in the time interval T3 before the currents of the inductors L1 and/or L2 cross the zero current. Specifically, during the time interval T6, the switching transistors M3-Q1 and M4-Q2 are turned on, and the switching transistors M1-Q2 and M2-Q1 are turned off. Meanwhile, the current of the inductor L1 or L2 is positive current, and the current flows through the body diode of the switching transistor M3-Q1 or the body diode of the switching transistor M4-Q2 to form a loop. As shown in FIG. 3, the direction of the current is similar to the current direction in the time interval T6. When the current of the inductor L1 or L2 reaches zero, the time interval T3 may start immediately to avoid the switching discontinuity when the time interval T6 proceeds to the next time interval T3.

Furthermore, during the time interval T4, the switching transistors M1-Q1 and M2-Q2 are turned on, and the switching transistors M3-Q2 and M4-Q1 are turned off. Meanwhile, the current of the inductor L1 or L2 is negative current, the direction of the current is similar to the current direction in the time interval T4. As shown in FIG. 6, when the current of the inductor L1 or L2 reaches zero, the time interval T5 in the next cycle may start immediately to avoid the switching discontinuity when the time interval T4 proceeds to the next time interval T5.

In addition, during the time interval T5, the switching transistors M3-Q1 and M4-Q2 are turned off. During the time interval T3, the switching transistors M1-Q1 and M2-Q2 are turned off. When the time intervals T5, T6, T3, and T4 are combined, the switching transistors M1-Q2, M2-Q1, M3-Q2, and M4-Q1 are turned off in the whole switching cycle; the switching transistors M1-Q1 and M2-Q2 are controlled by the first control signal; the switching transistors M3-Q1 and M4-Q2 are controlled by the second control signal. To reduce the circuit complexity and to extend the lifetime of transistors, the second control signal may be the voltage inverted from the first control signal. According to the above methods, the switching transistors M2-Q2 corresponds to the switching transistors M1-Q1, the switching transistors M2-Q1 corresponds to the switching transistors M1-Q2, the switching transistors M4-Q2 corresponds to the switching transistors M3-Q1, the switching transistors M4-Q1 corresponds to the switching transistors M3-Q2, and both corresponded switching transistors are controlled by the same control signal. In practice, when the corresponded switching transistors are controlled by the different control signals, and the different control signals have different duty cycles, then the voltage levels of the capacitors C1, C2, C3, C4 may be balanced.

According to the above mentioned methods, no matter the voltage level of the first power supply Bat is higher or lower than the voltage level of the second power supply PV, the first power supply Bat may discharge current to the second power supply PV, i.e. the second power supply PV is charged. In the process, the first power supply Bat of the DCDC double-direction converting device 100 may be regarded as the power supply source, and the second power supply PV may be regarded as the loading that consumes power. Similarly, the second power supply PV may be arranged to discharge current to the first power supply Bat. The second power supply PV may use the similar method to discharge current to the first power supply Bat by switching the roles between the second power supply PV and the first power supply Bat. Specifically, the switching transistor M1-Q1 corresponds to the switching transistor M3-Q1; the switching transistor M1-Q2 corresponds to the switching transistor M3-Q2; the switching transistor M2-Q1 corresponds to the switching transistor M4-Q1; and the switching transistor M2-Q2 corresponds to the switching transistor M4-Q2.

3. When the voltage level of the first power supply Bat is lower than the voltage level of the second power supply PV, the second power supply PV discharges current to the first power supply Bat.

3. When the second power supply PV is arranged to discharge current to the first power supply Bat, and when the voltage level of the second power supply PV is lower than the voltage level of the first power supply Bat, the DCDC double-direction converting device 100 is controlled to operate in a switching cycle having the time intervals T1′ and T2′, wherein the time intervals T1′ and T2′ are two consecutive time intervals, and the time interval T1′ is followed by the time interval T2′. During T2′, detecting if the current of the first inductor L1 and/or the current of the second inductor L2 crosses the zero current, if yes, controlling the DCDC double-direction converting device 100 to operate in the time intervals T3′, T4′, or the time intervals T7′, T8′ after time interval T2′. The detailed description of T1′˜T4′, T7′, and T8′ is described in below:

During the time intervals T1′: the switching transistors M3-Q1 and M1-Q2 are turned on, and the switching transistors M3-Q2 and M1-Q1 are turned off;

During the time intervals T2′: the switching transistor M1-Q2 is turned off;

During the time intervals T3′: the switching transistor M1-Q1 is turned on; and the switching transistors M3-Q2 and M1-Q2 are turned off;

During the time intervals T4′: the switching transistors M3-Q2 and M1-Q1 are turned off;

During the time intervals T7′: the switching transistors M3-Q2 and M1-Q1 are turned on, the switching transistors M3-Q1 and M1-Q2 are turned off;

During the time intervals T8′: the switching transistor M3-Q2 is turned off.

In addition, the switching transistors M2-Q2 and M1-Q1 are controlled by the same signal, the switching transistors M2-Q1 and M1-Q2 are controlled by the same signal, the switching transistors M4-Q2 and M3-Q1 are controlled by the same signal, and the switching transistors M4-Q1 and M3-Q2 are controlled by the same signal. The current directions are similar to the above-mentioned current directions, and the detailed description is omitted here for brevity.

When the voltage level of the first power supply Bat is higher than the voltage level of the second power supply PV, the second power supply PV discharges current to the first power supply Bat.

When the second power supply PV is arranged to discharge current to the first power supply Bat, and when the voltage level of the second power supply PV is higher than the voltage level of the first power supply Bat, the DCDC double-direction converting device 100 is controlled to operate in a switching cycle having the time intervals T5′ and T6′, wherein the time intervals T5′ and T5′ are two consecutive time intervals, and the time interval T5′ is followed by the time interval T6′. During T5′, detecting if the current of the first inductor L1 and/or the current of the second inductor L2 crosses the zero current, if yes, controlling the DCDC double-direction converting device 100 to operate in the time intervals T7′, T8′, or the time intervals T3′, T4′ after time interval T6′. The detailed description of T5′˜T8′, T3′, and T4′ is described in below:

During the time intervals T5′: the switching transistor M3-Q1 is turned on, and the switching transistors M1-Q2 and M3-Q2 are turned off;

During the time intervals T6′: the switching transistors M3-Q1 and M1-Q2 are turned off;

During the time intervals T7′: the switching transistors M3-Q2 and M1-Q1 are turned on; and the switching transistors M3-Q1 and M1-Q2 are turned off;

During the time intervals T8′: the switching transistor M3-Q2 is turned off;

During the time intervals T3′: the switching transistor M1-Q1 is turned on, the switching transistors M3-Q2 and M1-Q2 are turned off;

During the time intervals T4′: the switching transistors M3-Q2 and M1-Q1 are turned off.

In addition, the switching transistors M2-Q2 and M1-Q1 are controlled by the same signal, the switching transistors M2-Q1 and M1-Q2 are controlled by the same signal, the switching transistors M4-Q2 and M3-Q1 are controlled by the same signal, and the switching transistors M4-Q1 and M3-Q2 are controlled by the same signal. The current directions are similar to the above-mentioned current directions, and the detailed description is omitted here for brevity.

Similarly, when the second power supply PV is arranged to discharge current to the first power supply Bat, i.e. the first power supply Bat is charged, the second power supply PV of the DCDC double-direction converting device 100 may be regarded as the power supply source, and the first power supply Bat may be regarded as the loading that consumes power.

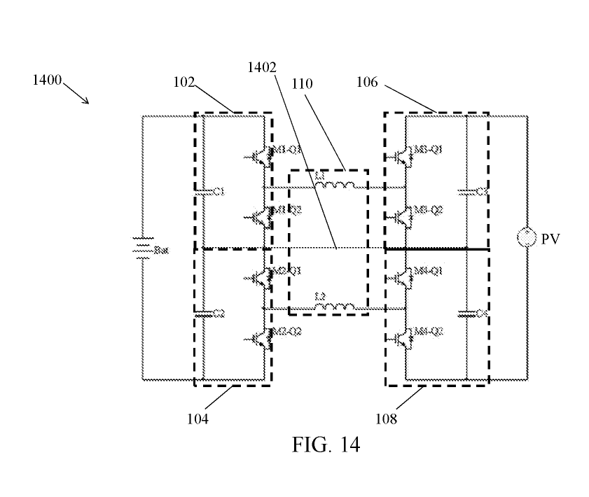

FIG. 14 is a diagram illustrating a DCDC (Direct Current to Direct Current) double-direction converting device 1400 in accordance with some embodiments. In comparison to the DCDC double-direction converting device 100, the DCDC double-direction converting device 1400 further comprises a connecting path 1402 connecting the second terminal (i.e. emitter) of the switching transistor M1-Q2 and the second terminal (i.e. emitter) of the switching transistor M3-Q2. For brevity, the numerals of other devices in FIG. 14 is similar to the device numerals in FIG. 1. Moreover, to more clearly describe the operation of the DCDC double-direction converting device 1400, the DCDC double-direction converting device 1400 is divided into an upper portion and a lower portion. The upper portion comprises capacitors C1, C3, the switching transistors M1-Q1, M1-Q2, M3-Q1, M3-Q2, and the inductor L1. The lower portion comprises capacitors C2, C4, the switching transistors M2-Q1, M2-Q2, M4-Q1, M4-Q2, and the inductor L2. The connecting path 1402 is defined as the central dividing point of the upper portion and the lower portion.

Similar to the DCDC double-direction converting device 100, the DCDC double-direction converting device 1400 may be operated in four modes, i.e. two Boost modes and two Buck modes as described in below paragraphs.

1. The first Boost mode, i.e. the first power supply Bat (i.e. the power battery pack) discharges the second power supply PV (i.e. the photovoltaic system):

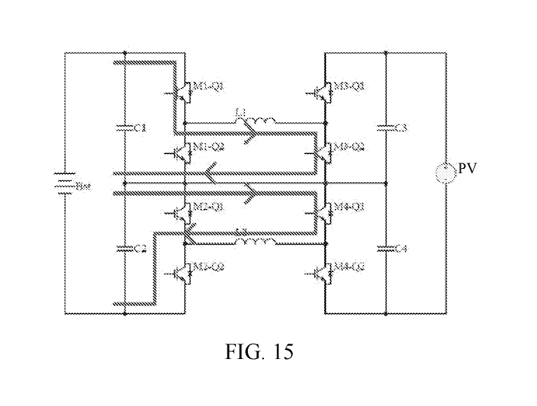

FIG. 15 is a diagram illustrating the first power supply Bat discharging the second power supply PV in accordance with some embodiments. FIG. 15 shows an equivalent model of storing energy in a Boost mode.

For the upper portion, the switching transistors M1-Q1 and M3-Q2 are turned on, the switching transistors M1-Q2 and M3-Q1 are turned off. Meanwhile, the current flows from the first terminal of capacitor C1 (i.e. the positive terminal of the first power supply Bat) to the second terminal of capacitor C2 (i.e. the central dividing point) through the switching transistor M1-Q1, the first inductor L1, and the switching transistor M3-Q2.

For the lower portion, the switching transistors M4-Q1 and M2-Q2 are turned on, the switching transistors M4-Q2 and M2-Q1 are turned off. Meanwhile, the current flows from the first terminal of capacitor C2 (i.e. the central dividing point) to the second terminal of capacitor C2 (i.e. the negative terminal of the first power supply Bat) through the switching transistor M4-Q1, the second inductor L2, and the switching transistor M2-Q2.

During the process, the capacitor C1 and capacitor C2 are discharged, and the first inductor L1 and the second inductor L2 are energy stored. As the discharging currents of the capacitor C1 and the capacitor C2 are provided by the first power supply Bat, the first power supply Bat is discharged.

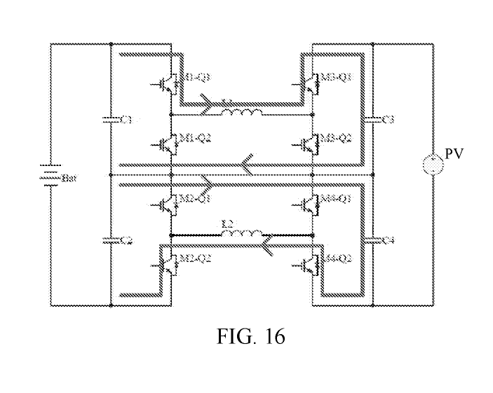

FIG. 16 is a diagram illustrating the first power supply Bat discharging the second power supply PV in accordance with some embodiments. FIG. 16 shows an equivalent model of current flyback in a Boost mode.

For the upper portion, the switching transistor M1-Q1 is turned on, and the switching transistors M3-Q2 and M1-Q2 are turned off. Meanwhile, the current flows from the first terminal of the first inductor L1 to the second terminal of the first inductor L1 through the body diode of the switching transistor M3-Q1, the first terminal of the capacitor C3 (i.e. the positive terminal of the photovoltaic system), the second terminal of the capacitor C3 (i.e. the negative terminal of the photovoltaic system), the first terminal C1, and the switching transistor M1-Q1.

For the lower portion, the switching transistors M4-Q1 and M2-Q1 are turned off, and the switching transistor M2-Q2 is turned on. Meanwhile, the current flows from the first terminal of the inductor L2 to the second terminal of the inductor L2 through the switching transistor M2-Q2, the capacitor C2, the first terminal of the capacitor C4 (i.e. the central dividing point), the second terminal of the capacitor C4 (i.e. the negative terminal of the photovoltaic system), and the body diode of the switching transistor M4-Q2.

During the process, the energy of the first inductor L1 and the second inductor L2 is released or discharged, and the capacitor C3 and the capacitor C4 are charged. As the capacitor C3 and the capacitor C4 are serially connected between the positive terminal of the second power supply PV and the negative terminal of the second power supply PV, the charging of the capacitor C3 and the capacitor C4 means that the energy of the second power supply PV also charges.

Accordingly, the equivalent models of FIG. 15 and FIG. 16 are capable of discharging current to the capacitor C3 and the capacitor C4 from the capacitor C1 and the capacitor C2. Accordingly, the first power supply Bat may discharge current to the second power supply PV during the first Boost mode, i.e. the voltage up-converting mode.

2. The first Buck mode, i.e. the first power supply Bat (i.e. the power battery pack) discharges the second power supply PV (i.e. the photovoltaic system):

As shown in FIG. 16, the first power supply Bat may discharge the second power supply PV.

For the upper portion, the switching transistors M1-Q1 and M3-Q2 are turned off. Meanwhile, the current flows from the first terminal of capacitor C1 (i.e. the positive terminal of the first power supply Bat) to the second terminal of the capacitor C3 (i.e. the second terminal of capacitor C1, or the central dividing point) through the switching transistor M1-Q1, the first inductor L1, the body diode of the switching transistor M3-Q1, and the first terminal of the capacitor C3 (i.e. the positive terminal of the photovoltaic system).

For the lower portion, the switching transistors M4-Q1 and M2-Q2 are turned off. Meanwhile, the current flows from the first terminal of capacitor C2 (i.e. the central dividing point or the first terminal of the capacitor C4) to the second terminal of the capacitor C2 (i.e. the negative terminal of the first power supply Bat) through the second terminal of the capacitor C4 (i.e. the negative terminal of the photovoltaic system), the body diode of the switching transistor M4-Q2, the second inductor L2, and the switching transistor M2-Q2.

During the process, the capacitor C1 and capacitor C2 are discharged, the capacitor C3 and capacitor C4 are charged, and the energy of the first inductor L1 and the second inductor L2 is charged or stored. The discharging currents of the capacitor C1 and the capacitor C2 are provided by the first power supply Bat. As the capacitor C3 and the capacitor C4 are serially connected between the positive terminal of the second power supply PV and the negative terminal of the second power supply PV, the charging of the capacitor C3 and the capacitor C4 means that the energy of the second power supply PV also charges.

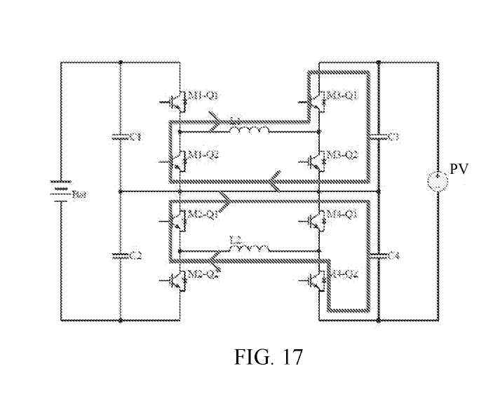

As shown in FIG. 17, the first power supply Bat may discharge the second power supply PV, which is an equivalent model of current flyback in a Buck mode.

For the upper portion, the switching transistors M1-Q1 and M3-Q2 are turned off. Meanwhile, the current flows from the first terminal of the first inductor L1 to the second terminal of the first inductor L1 through the body diode of the switching transistor M3-Q1, the first terminal of the capacitor C3 (i.e. the positive terminal of the photovoltaic system), the second terminal of the capacitor C3 (i.e. the central dividing point), and the body diode of the switching transistor M1-Q2.

The first inductor L1 releases energy through the body diode of the switching transistor M3-Q1, the first terminal of the capacitor C3 (i.e. the positive terminal of the photovoltaic system), the second terminal of the capacitor C3 (i.e. the central dividing point), and the body diode of the switching transistor M1-Q2.

For the lower portion, the switching transistors M4-Q1 and M2-Q2 are turned off. Meanwhile, the current flows from the first terminal of the second inductor L2 to the second terminal of the second inductor L2 through the body diode of the switching transistor M2-Q1, the first terminal of the capacitor C4 (i.e. the central dividing point), the second terminal of the capacitor C4 (i.e. the negative terminal of the photovoltaic system), and the body diode of the switching transistor M4-Q2.

During the process, the energy of the first inductor L1 and the second inductor L2 is released or discharged, and the capacitor C3 and the capacitor C4 are charged. As the capacitor C3 and the capacitor C4 are serially connected between the positive terminal of the second power supply PV and the negative terminal of the second power supply PV, the charging of the capacitor C3 and the capacitor C4 means that the energy of the second power supply PV also charges.

Accordingly, the equivalent models of FIG. 16 and FIG. 17 are capable of discharging current to the capacitor C3 and the capacitor C4 from the capacitor C1 and the capacitor C2. Accordingly, the first power supply Bat may discharge current to the second power supply PV during the first Buck mode, i.e. the voltage down-converting mode.

3. The second Boost mode, i.e. the second power supply PV (i.e. the photovoltaic system) charges the first power supply Bat (i.e. the power battery pack):

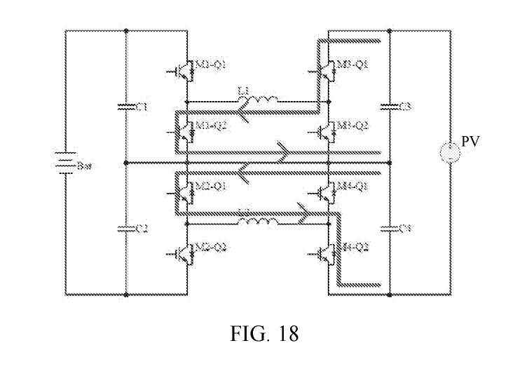

FIG. 18 is a diagram illustrating the first power supply Bat charging the second power supply PV in accordance with some embodiments, which is an equivalent model of storing energy in a Boost mode.

For the upper portion, the switching transistors M3-Q1 and M1-Q2 are turned on, the switching transistors M3-Q2 and M1-Q1 are turned off. Meanwhile, the current flows from the first terminal of capacitor C3 (i.e. the positive terminal of the second power supply PV) to the second terminal of capacitor C3 (i.e. the central dividing point) through the switching transistor M3-Q1, the first inductor L1, and the switching transistor M1-Q2.

For the lower portion, the switching transistors M2-Q1 and M4-Q2 are turned on, the switching transistors M2-Q2 and M4-Q1 are turned off. Meanwhile, the current flows from the first terminal of capacitor C4 (i.e. the central dividing point) to the second terminal of capacitor C4 (i.e. the negative terminal of the second power supply PV) through the switching transistor M2-Q1, the second inductor L2, and the switching transistor M4-Q2.

During the process, the capacitor C3 and capacitor C4 are discharged, and the first inductor L1 and the second inductor L2 are energy stored. The discharging currents of the capacitor C3 and the capacitor C4 are provided by the second power supply PV.

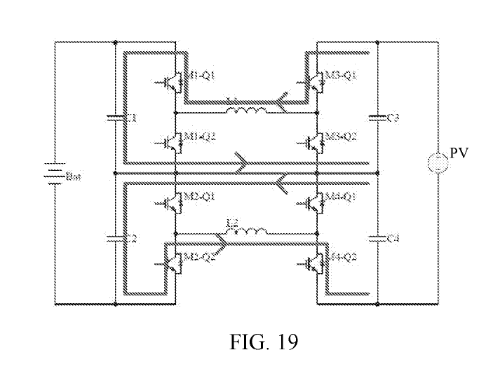

FIG. 19 is a diagram illustrating the second power supply PV discharging the first power supply Bat in accordance with some embodiments. FIG. 19 shows an equivalent model of current flyback in a Boost mode.

For the upper portion, the switching transistor M3-Q1 is turned on, and the switching transistors M1-Q2 and M3-Q2 are turned off. Meanwhile, the current flows from the first terminal of the first inductor L1 to the second terminal of the first inductor L1 through the body diode of the switching transistor M1-Q1, the first terminal of the capacitor C1 (i.e. the positive terminal of the first power supply Bat), the second terminal of the capacitor C1 (i.e. the central dividing point or the second terminal of the capacitor C3), the first terminal of the capacitor C3, and the switching transistor M3-Q1.

For the lower portion, the switching transistors M2-Q1 and M4-Q1 are turned off, and the switching transistor M4-Q2 is turned on. Meanwhile, the current flows from the first terminal of the inductor L2 to the second terminal of the inductor L2 through the switching transistor M4-Q2, the second terminal of the capacitor C2, the first terminal of the capacitor C4 (i.e. the central dividing point), the second terminal of the capacitor C2 (i.e. the negative terminal of the first power supply Bat), and the body diode of the switching transistor M2-Q2.

During the process, the energy of the first inductor L1 and the second inductor L2 is released or discharged, and the capacitor C1 and the capacitor C2 are charged. As the capacitor C1 and the capacitor C2 are serially connected between the positive terminal of the first power supply Bat and the negative terminal of the first power supply Bat, the charging of the capacitor C1 and the capacitor C2 means that the energy of the first power supply Bat also charges.

Accordingly, the equivalent models of FIG. 18 and FIG. 19 are capable of charging current to the capacitor C1 and the capacitor C2 from the capacitor C3 and the capacitor C4. Accordingly, the second power supply PV may charge the first power supply Bat during the second Boost mode, i.e. the voltage up-converting mode.

4. The second Buck mode, i.e. the second power supply PV charges the first power supply Bat:

As shown in FIG. 19, the second power supply PV may charge the first power supply Bat, which is an equivalent model of storing energy in a Buck mode.

For the upper portion, the switching transistor M3-Q1 is turned on, the switching transistors M1-Q2 and M3-Q2 are turned off. Meanwhile, the current flows from the first terminal of capacitor C3 (i.e. the positive terminal of the second power supply PV) to the second terminal of capacitor C1 (i.e. the central dividing point) through the switching transistor M3-Q1, the first inductor L1, and the body diode of the switching transistor M1-Q1, the first terminal of the capacitor C1.

For the lower portion, the switching transistors M2-Q1 and M4-Q2 are turned off, the switching transistor M4-Q2 is turned on. Meanwhile, the current flows from the first terminal of capacitor C4 (i.e. the central dividing point) to the second terminal of capacitor C4 (i.e. the negative terminal of the second power supply PV) through the second terminal of the capacitor C2, the body diode of the switching transistor M2-Q2, the second inductor L2, and the switching transistor M4-Q2.

During the process, the energy of the first inductor L1 and the second inductor L2 is stored, the capacitor C3 and the capacitor C4 are discharged, and the capacitor C1 and the capacitor C2 are charged. The discharging currents of the capacitor C3 and the capacitor C4 are provided by the second power supply PV. As the capacitor C1 and the capacitor C2 are serially connected between the positive terminal of the first power supply Bat and the negative terminal of the first power supply Bat, the charging of the capacitor C1 and the capacitor C2 means that the energy of the first power supply Bat also charges.

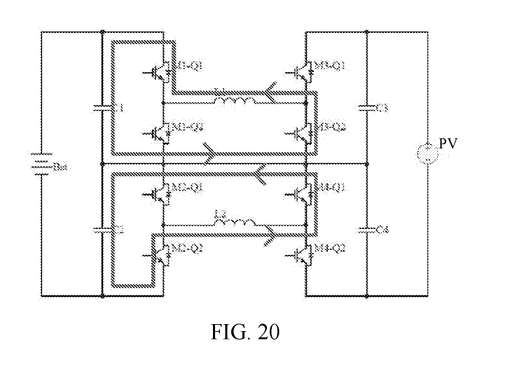

As shown in FIG. 20, the second power supply PV may charge the first power supply Bat, which is an equivalent model of current flyback in a Buck mode.

For the upper portion, the switching transistors M3-Q1 and M1-Q2 are turned off. Meanwhile, the current flows from the first terminal of the first inductor L1 to the second terminal of the first inductor L1 through the body diode of the switching transistor M1-Q1, the first terminal of the capacitor C1 (i.e. the positive terminal of the first power supply Bat), the second terminal of the capacitor C1 (i.e. the central dividing point), and the body diode of the switching transistor M3-Q2.

For the lower portion, the switching transistors M2-Q1 and M4-Q2 are turned off. Meanwhile, the current flows from the first terminal of the second inductor L2 to the second terminal of the second inductor L2 through the body diode of the switching transistor M4-Q1, the first terminal of the capacitor C2 (i.e. the central dividing point), the second terminal of the capacitor C2 (i.e. the negative terminal of the first power supply Bat), and the body diode of the switching transistor M2-Q2.

During the process, the energy of the first inductor L1 and the second inductor L2 is released or discharged, and the capacitor C1 and the capacitor C2 are charged. As the capacitor C1 and the capacitor C2 are serially connected between the positive terminal of the first power supply Bat and the negative terminal of the first power supply Bat, the charging of the capacitor C1 and the capacitor C2 means that the energy of the first power supply Bat also charges.

Accordingly, the equivalent models of FIG. 19 and FIG. 20 are capable of charging current to the capacitor C1 and the capacitor C2 from the capacitor C3 and the capacitor C4. Accordingly, the second power supply PV may charge the first power supply Bat during the second Buck mode, i.e. the voltage down-converting mode.

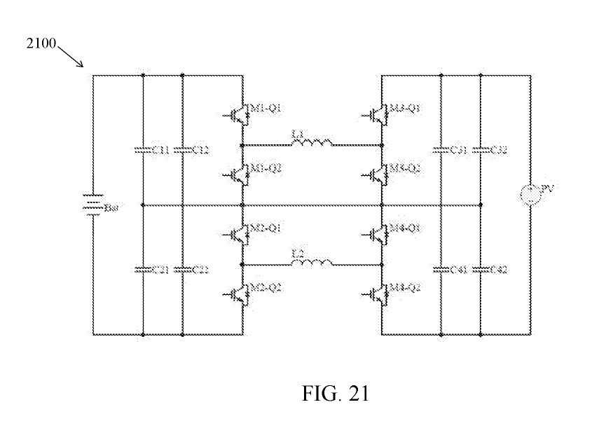

FIG. 21 is a diagram illustrating a DCDC double-direction converting device 2100 in accordance with some embodiments. In comparison to the DCDC double-direction converting device 1400 of FIG. 14, the DCDC double-direction converting device 2100 comprises more capacitors in the bridge circuits.

In FIG. 21, the first capacitor C1 of the DCDC double-direction converting device 1400 is replaced with two capacitors C11, C12 connected in parallel. The second capacitor C2 of the DCDC double-direction converting device 1400 is replaced with two capacitors C21, C22 connected in parallel. The third capacitor C3 of the DCDC double-direction converting device 1400 is replaced with two capacitors C31, C32 connected in parallel. The fourth capacitor C4 of the DCDC double-direction converting device 1400 is replaced with two capacitors C41, C42 connected in parallel. The operation and benefit of the DCDC double-direction converting device 2100 is similar to the DCDC double-direction converting device 1400, thus the detailed description is omitted here for brevity.

Moreover, according to some embodiments, the capacitance of the capacitor C1 is equal to the capacitance of the capacitor C2, and the capacitance of the capacitor C3 is equal to the capacitance of the capacitor C4.

Similar to the DCDC double-direction converting device 100, the DCDC double-direction converting device 1400 may be operated in the following four modes:

1. When the voltage level of the first power supply Bat is lower than the voltage level of the second power supply PV, the first power supply Bat discharges current to the second power supply PV.

2. When the voltage level of the first power supply Bat is higher than the voltage level of the second power supply PV, the first power supply Bat discharges current to the second power supply PV.

3. When the voltage level of the first power supply Bat is lower than the voltage level of the second power supply PV, the second power supply PV discharges current to the first power supply Bat.

4. When the voltage level of the first power supply Bat is higher than the voltage level of the second power supply PV, the second power supply PV discharges current to the first power supply Bat.

The above mentioned four controlling methods of the DCDC double-direction converting device 1400 is described in detail in the following paragraphs and diagrams.

1. When the voltage level of the first power supply Bat is lower than the voltage level of the second power supply PV, the first power supply Bat discharges current to the second power supply PV, and the controlling method is as followed:

When the first power supply Bat is arranged to discharge current to the second power supply PV, and when the voltage level of the first power supply Bat is lower than the voltage level of the second power supply PV, the DCDC double-direction converting device 1400 is controlled to operate in a switching cycle having a first time interval T1 and a second time interval T2. During T2, detecting if the current of the first inductor L1 and/or the current of the second inductor L2 crosses the zero current, if yes, controlling the DCDC double-direction converting device 100 to operate in the time intervals T3, T4, or the time intervals T7, T8 after time interval T2.

During the time interval T1, the operation (i.e. on or off) of the switching transistors in the DCDC double-direction converting device 1400 and the flowing currents in the DCDC double-direction converting device 1400 have been described and shown in FIG. 15, and the detailed description is omitted here for brevity.

During the time interval T2, the operation (i.e. on or off) of the switching transistors in the DCDC double-direction converting device 1400 and the flowing currents in the DCDC double-direction converting device 1400 have been described and shown in FIG. 16 and FIG. 17, and the detailed description is omitted here for brevity.

During the time interval T3, the operation (i.e. on or off) of the switching transistors in the DCDC double-direction converting device 1400 and the flowing currents in the DCDC double-direction converting device 1400 have been described and shown in FIG. 18, and the detailed description is omitted here for brevity.

During the time interval T4, the operation (i.e. on or off) of the switching transistors in the DCDC double-direction converting device 1400 and the flowing currents in the DCDC double-direction converting device 1400 have been described and shown in FIG. 19, and the detailed description is omitted here for brevity.

When the DCDC double-direction converting device 1400 is arranged to operate in the switching cycle having the time intervals T1, T2, T1, T2, the variation of the control signals of the switching transistor M1-Q1, M1-Q2, M2-Q1, M2-Q2, M3-Q1, M3-Q2, M4-Q1, M4-Q2, the current (i.e. IL1) of the inductor L1, and the current (i.e. IL2) of the inductor L2 in the DCDC double-direction converting device 1400 is similar to the above-mentioned FIG. 9, and the detailed description is omitted here for brevity.

When the DCDC double-direction converting device 1400 is arranged to operate in the switching cycle having the time intervals T1, T2, T3, T4, the variation of the control signals of the switching transistor M1-Q1, M1-Q2, M2-Q1, M2-Q2, M3-Q1, M3-Q2, M4-Q1, M4-Q2, the current (i.e. IL1) of the inductor L1, and the current (i.e. IL2) of the inductor L2 in the DCDC double-direction converting device 1400 is similar to the above-mentioned FIG. 10, and the detailed description is omitted here for brevity.

When the DCDC double-direction converting device 1400 is arranged to operate in the switching cycle having the time intervals T1, T2, T7, T8, the variation of the control signals of the switching transistor M1-Q1, M1-Q2, M2-Q1, M2-Q2, M3-Q1, M3-Q2, M4-Q1, M4-Q2, the current (i.e. IL1) of the inductor L1, and the current (i.e. IL2) of the inductor L2 in the DCDC double-direction converting device 1400 is similar to the above-mentioned FIG. 11, and the detailed description is omitted here for brevity.

2. When the voltage level of the first power supply Bat is higher than the voltage level of the second power supply PV, the first power supply Bat is arranged to discharge current to the second power supply PV according to the following method:

When the first power supply Bat is arranged to discharge current to the second power supply PV, and when the voltage level of the first power supply Bat is higher than the voltage level of the second power supply PV, the DCDC double-direction converting device 1400 is controlled to operate in a switching cycle having the time interval T5 and the time interval T6. During T6, detecting if the current of the first inductor L1 and/or the current of the second inductor L2 crosses the zero current, if yes, controlling the DCDC double-direction converting device 100 to operate in the time intervals T7, T8, or the time intervals T3, T4 after time interval T6. After the time intervals T5, T6, the DCDC double-direction converting device 100 may be controlled to operate in the time intervals T7, T8.

During the time interval T5, the operation (i.e. on or off) of the switching transistors in the DCDC double-direction converting device 1400 and the flowing currents in the DCDC double-direction converting device 1400 have been described and shown in FIG. 16, and the detailed description is omitted here for brevity.

During the time interval T6, the operation (i.e. on or off) of the switching transistors in the DCDC double-direction converting device 1400 and the flowing currents in the DCDC double-direction converting device 1400 have been described and shown in FIG. 17, and the detailed description is omitted here for brevity.

When the DCDC double-direction converting device 1400 is arranged to operate in the switching cycle having the time intervals T5, T6, T7, T8, the variation of the control signals of the switching transistor M1-Q1, M1-Q2, M2-Q1, M2-Q2, M3-Q1, M3-Q2, M4-Q1, M4-Q2, the current (i.e. IL1) of the inductor L1, and the current (i.e. IL2) of the inductor L2 in the DCDC double-direction converting device 1400 is similar to the above-mentioned FIG. 12, and the detailed description is omitted here for brevity.

When the DCDC double-direction converting device 1400 is arranged to operate in the switching cycle having the time intervals T5, T6, T3, T4, the variation of the control signals of the switching transistor M1-Q1, M1-Q2, M2-Q1, M2-Q2, M3-Q1, M3-Q2, M4-Q1, M4-Q2, the current (i.e. IL1) of the inductor L1, and the current (i.e. IL2) of the inductor L2 in the DCDC double-direction converting device 1400 is similar to the above-mentioned FIG. 13, and the detailed description is omitted here for brevity.

3. When the voltage level of the first power supply Bat is lower than the voltage level of the second power supply PV, the second power supply PV discharges current to the first power supply Bat.

When the second power supply PV is arranged to discharge current to the first power supply Bat, and when the voltage level of the second power supply PV is lower than the voltage level of the first power supply Bat, the DCDC double-direction converting device 1400 is controlled to operate in a switching cycle having the time intervals T1′ and T2′. During T2′, detecting if the current of the first inductor L1 and/or the current of the second inductor L2 crosses the zero current, if yes, controlling the DCDC double-direction converting device 1400 to operate in the time intervals T3′, T4′, or the time intervals T7′, T8′ after time interval T2′. The detailed description of T1′˜T4′, T7′, and T8′ is described in below:

During the time intervals T1′: the switching transistors M3-Q1 and M1-Q2 are turned on, and the switching transistors M3-Q2 and M1-Q1 are turned off;

During the time intervals T2′: the switching transistor M1-Q2 is turned off;

During the time intervals T3′: the switching transistor M1-Q1 is turned on; and the switching transistors M3-Q2 and M1-Q2 are turned off;

During the time intervals T4′: the switching transistors M3-Q2 and M1-Q1 are turned off;

During the time intervals T7′: the switching transistors M3-Q2 and M1-Q1 are turned on, the switching transistors M3-Q1 and M1-Q2 are turned off;

During the time intervals T8′: the switching transistor M3-Q2 is turned off.

In addition, the switching transistors M2-Q2 and M1-Q1 are controlled by the same signal, the switching transistors M2-Q1 and M1-Q2 are controlled by the same signal, the switching transistors M4-Q2 and M3-Q1 are controlled by the same signal, and the switching transistors M4-Q1 and M3-Q2 are controlled by the same signal. The current directions are similar to the above-mentioned current directions, and the detailed description is omitted here for brevity.

4. When the voltage level of the first power supply Bat is higher than the voltage level of the second power supply PV, the second power supply PV discharges current to the first power supply Bat.

When the second power supply PV is arranged to discharge current to the first power supply Bat, and when the voltage level of the second power supply PV is higher than the voltage level of the first power supply Bat, the DCDC double-direction converting device 1400 is controlled to operate in a switching cycle having the time intervals T5′ and T6′, wherein the time intervals T5′ and T5′ are two consecutive time intervals, and the time interval T5′ is followed by the time interval T6′. During T5′, detecting if the current of the first inductor L1 and/or the current of the second inductor L2 crosses the zero current, if yes, controlling the DCDC double-direction converting device 1400 to operate in the time intervals T7′, T8′, or the time intervals T3′, T4′ after time interval T6′. The detailed description of T5′˜T8′, T3′, and T4′ is described in below:

During the time intervals T5′: the switching transistor M3-Q1 is turned on, and the switching transistors M1-Q2 and M3-Q2 are turned off;

During the time intervals T6′: the switching transistors M3-Q1 and M1-Q2 are turned off;

During the time intervals T7′: the switching transistors M3-Q2 and M1-Q1 are turned on; and the switching transistors M3-Q1 and M1-Q2 are turned off;

During the time intervals T8′: the switching transistor M3-Q2 is turned off;

During the time intervals T3′: the switching transistor M1-Q1 is turned on, the switching transistors M3-Q2 and M1-Q2 are turned off;

During the time intervals T4′: the switching transistors M3-Q2 and M1-Q1 are turned off.

In addition, the switching transistors M2-Q2 and M1-Q1 are controlled by the same signal, the switching transistors M2-Q1 and M1-Q2 are controlled by the same signal, the switching transistors M4-Q2 and M3-Q1 are controlled by the same signal, and the switching transistors M4-Q1 and M3-Q2 are controlled by the same signal. The current directions are similar to the above-mentioned current directions, and the detailed description is omitted here for brevity.

Similarly, when the second power supply PV is arranged to discharge current to the first power supply Bat, i.e. the first power supply Bat is charged, the second power supply PV of the DCDC double-direction converting device 1400 may be regarded as the power supply source, and the first power supply Bat may be regarded as the loading that consumes power.

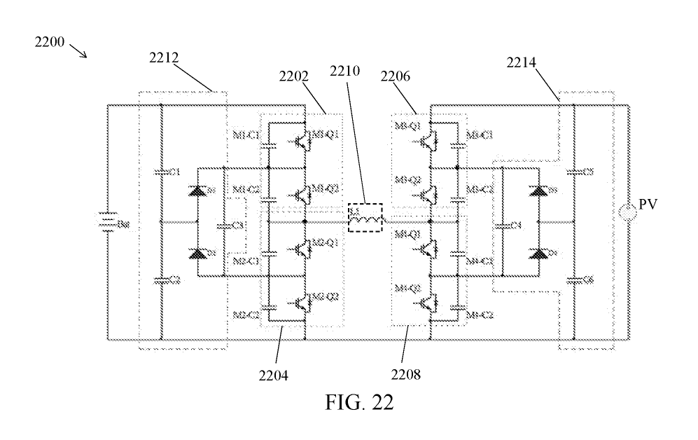

FIG. 22 is a diagram illustrating a DCDC (Direct Current to Direct Current) double-direction converting device 2200 in accordance with some embodiments. The DCDC double-direction converting device 2200 comprises a first power supply Bat, a first bridge circuit 2202, a second bridge circuit 2204, a second power supply PV, a third bridge circuit 2206, a fourth bridge circuit 2208, an inductive circuit 2210, a first connecting circuit 2212, and a second connecting circuit 2214.

According to some embodiments, the first bridge circuit 2202 comprises a first capacitor M1-C1, a first switching transistor M1-Q1, a second capacitor M1-C2, and a second switching transistor M1-C2. The first capacitor M1-C1 has a first terminal coupled to the first positive terminal of the first power supply Bat. The first switching transistor M1-Q1 has a first terminal coupled to the first terminal of the first capacitor M1-C1, and a second terminal coupled to a second terminal of the first capacitor M1-C1. The second capacitor M1-C2 has a first terminal coupled to the second terminal of the first capacitor M1-C1. The second switching transistor M1-Q2 has a first terminal coupled to the first terminal of the second capacitor M1-C2, and a second terminal coupled to a second terminal of the first capacitor M1-C1.

The second bridge circuit 2204 comprises a third capacitor M2-C1, a third switching transistor M2-Q1, a fourth capacitor M2-C2, and a fourth switching transistor M2-Q2. The third capacitor M2-C1 has a first terminal coupled to the second terminal of the second capacitor M1-C2. The third switching transistor M2-Q1 has a first terminal coupled to the first terminal of the third capacitor M2-C1, and a second terminal coupled to a second terminal of the third capacitor M2-C1. The fourth capacitor M2-C2 has a first terminal coupled to the second terminal of the third capacitor M2-C1. The fourth switching transistor M2-Q2 has a first terminal coupled to the first terminal of the fourth capacitor M2-C2, and a second terminal coupled to a second terminal of the fourth capacitor M2-C2.

The third bridge circuit 2206 comprises a fifth capacitor M3-C1, a fifth switching transistor M3-Q1, a sixth capacitor M3-C2, and a sixth switching transistor M3-Q2. The fifth capacitor M3-C1 has a first terminal coupled to the second positive terminal of the second power supply PV. The fifth switching transistor M3-Q1 has a first terminal coupled to the first terminal of the fifth capacitor M3-C1, and a second terminal coupled to a second terminal of the fifth capacitor M3-C1. The sixth capacitor M3-C2 has a first terminal coupled to the second terminal of the fifth capacitor M3-C1. The sixth switching transistor M3-Q2 has a first terminal coupled to the first terminal of the sixth capacitor M3-C2, and a second terminal coupled to a second terminal of the sixth capacitor M3-C2.

The fourth bridge circuit 2208 comprises a seventh capacitor M4-C1, a seventh switching transistor M4-Q1, an eighth capacitor M4-C2, and an eighth switching transistor M4-Q2. The seventh capacitor M4-C1 has a first terminal coupled to the second terminal of the sixth capacitor M3-C2. The seventh switching transistor M4-Q1 has a first terminal coupled to the first terminal of the seventh capacitor M4-C1, and a second terminal coupled to a second terminal of the seventh capacitor M4-C1. The eighth capacitor M4-C2 has a first terminal coupled to the second terminal of the seventh capacitor M4-C1. The eighth switching transistor M4-Q2 has a first terminal coupled to the first terminal of the eighth capacitor M4-C2, and a second terminal coupled to a second terminal of the eighth capacitor M4-C2.

The inductive circuit 2210 comprises an inductor L1. The inductor L1 has a first terminal coupled to the second terminal of the second switching transistor M1-Q2, and a second terminal coupled to the second terminal of the sixth switching transistor M3-Q2.

The first connecting circuit 2212 comprises a ninth capacitor C1, a tenth capacitor C2, an eleventh capacitor C3, a first diode D1, and a second diode D2. The ninth capacitor C1 has a first terminal coupled to the first positive terminal of the first power supply Bat. The tenth capacitor C2 has a first terminal coupled to a second terminal of the ninth capacitor C1, and a second terminal coupled to the first negative terminal of the first power supply Bat. The eleventh capacitor C3 has a first terminal coupled to the second terminal of the first capacitor M1-C1, and a second terminal coupled to the second terminal of the third capacitor M2-C1. The first diode D1 has an anode coupled to the second terminal of the ninth capacitor C1, and a cathode coupled to the first terminal of the eleventh capacitor C3. The second diode D2 has an anode coupled to the second terminal of the eleventh capacitor C3, and a cathode coupled to the second terminal of the ninth capacitor C1.

The second connecting circuit 2214 comprises a twelfth capacitor C5, a thirteenth capacitor C6, a fourteenth capacitor C4, a third diode D3, and a fourth diode D4. The twelfth capacitor C5 has a first terminal coupled to the second positive terminal of the second power supply PV. The thirteenth capacitor C6 has a first terminal coupled to a second terminal of the twelfth capacitor C5, and a second terminal coupled to the second negative terminal of the second power supply PV. The fourteenth capacitor C4 has a first terminal coupled to the second terminal of the fifth capacitor M3-C1 and a second terminal coupled to the seventh capacitor M4-C1. The third diode D3 has an anode coupled to the second terminal of the twelfth capacitor C5, and a cathode coupled to the first terminal of the fourteenth capacitor C4. The fourth diode D4 has an anode coupled to the second terminal of the fourteenth capacitor C4, and a cathode coupled to the second terminal of the twelfth capacitor C5.

According to some embodiments, the first capacitor M1-C1, the second capacitor M1-C2, the third capacitor M2-C1, the fourth capacitor M2-C2, the fifth capacitor M3-C1, the sixth capacitor M3-C2, the seventh capacitor M4-C1, and the eighth capacitor M4-C2 have a first capacitance, a second capacitance, a third capacitance, a fourth capacitance, a fifth capacitance, a sixth capacitance, a seventh capacitance, and an eighth capacitance respectively, the first capacitance and the second capacitance are equal to the third capacitance and the fourth capacitance respectively, and the fifth capacitance and the sixth capacitance are equal to the seventh capacitance and the eighth capacitance respectively.

In addition, the capacitors C1 and C2 are bus capacitor. The diodes D1 and D2 are used to clamp voltage. The capacitor C3 is bridge capacitor or flying capacitor. The capacitors C5 and C6 are bus capacitor. The diodes D3 and D4 are used to clamp voltage. The capacitor C4 is bridge capacitor or flying capacitor. Furthermore, the capacitors M1-C1, M1-C2, M2-C1, M2-C2, M3-C1, M3-C2, M4-C1, and M4-C2 are not polarized capacitor.

The following paragraphs describes the operation of the DCDC double-direction converting device 2200. According to some embodiments, the DCDC double-direction converting device 2200 is configured to have four operating modes, i.e. two Boost modes and two Buck modes. However, this is not a limitation of the present invention.

1. The first Boost mode, i.e. the first power supply Bat (i.e. the power battery pack) discharges the second power supply PV (i.e. the photovoltaic system):

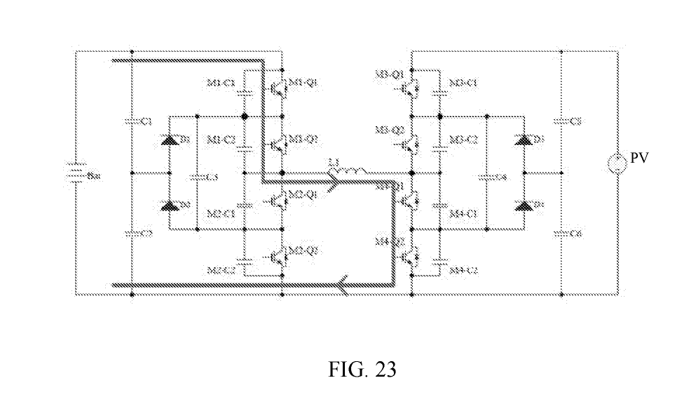

1) FIG. 23 is a diagram illustrating the first power supply Bat discharging the second power supply PV in accordance with some embodiments. FIG. 23 shows an equivalent model of storing energy in a Boost mode.

During the storing energy, the switching transistors M1-Q1, M1-Q2, M4-Q1, and M4-Q2 are turned on, the switching transistors M2-Q1, M2-Q2, M3-Q1, and M3-Q2 are turned off. As shown in FIG. 23, the current flows from the positive terminal (i.e. the first terminal of capacitor C1) of the first power supply Bat to the negative terminal (i.e. the second terminal of capacitor C2) of the first power supply Bat through the switching transistor M1-Q1, the switching transistor M1-Q2, the inductor L1, the switching transistor M4-Q1, the switching transistor M4-Q2. During the process, the energy of the capacitor C1 and capacitor C2 is discharged, and the energy of the inductor L1 is charged or stored. As the capacitor C1 and the capacitor C2 are serially connected between the positive terminal of the first power supply Bat and the negative terminal of the first power supply Bat, the discharging of the capacitor C1 and the capacitor C2 means that the energy of the first power supply Bat also discharges.

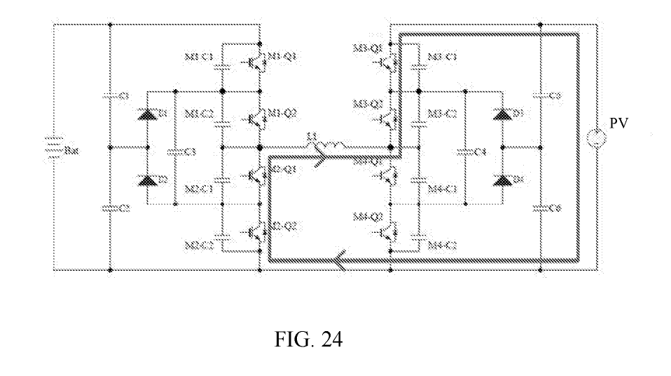

2) FIG. 24 is a diagram illustrating the first power supply Bat discharging the second power supply PV in accordance with some embodiments. FIG. 24 shows an equivalent model of current flyback in a Boost mode.

During the current flyback, the switching transistors M1-Q1, M1-Q2 are turned on, the switching transistors M2-Q1, M2-Q2, M4-Q1, and M4-Q2 are turned off. As shown in FIG. 24, the current flows from the first terminal of the inductor L1 to the second terminal of the inductor L1 through the body diode of the switching transistor M3-Q2, the body diode of the switching transistor M3-Q1, the capacitor C5, the capacitor C6, the body diode of the switching transistor M2-Q2, and the body diode of the switching transistor M2-Q1. During the process, the capacitor C5 and capacitor C6 are charged, and the energy of the inductor L1 is released. As the capacitor C5 and the capacitor C6 are serially connected between the positive terminal of the second power supply PV and the negative terminal of the second power supply PV, the charging of the capacitor C5 and the capacitor C6 means that the energy of the second power supply PV also charges.

Accordingly, the equivalent models of FIG. 23 and FIG. 24 are capable of discharging current to the capacitor C5 and the capacitor C6 from the capacitor C1 and the capacitor C2. Accordingly, the first power supply Bat may discharge current to the second power supply PV during the first Boost mode, i.e. the voltage up-converting mode.

2. The first Buck mode, i.e. the first power supply Bat (i.e. the power battery pack) discharges the second power supply PV (i.e. the photovoltaic system):

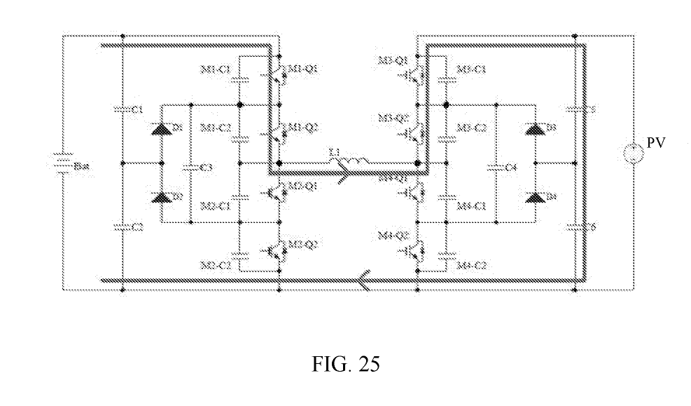

1) FIG. 25 is a diagram illustrating the first power supply Bat discharging the second power supply PV in accordance with some embodiments. FIG. 25 shows an equivalent model of storing energy in a Buck mode.

During the storing energy, the switching transistors M1-Q1 and M1-Q2 are turned on, and the switching transistors M2-Q1, M2-Q2, M4-Q1, and M4-Q2 are turned off. As shown in FIG. 25, the current flows from the positive terminal (i.e. the first terminal of capacitor C1) of the first power supply Bat to the negative terminal (i.e. the second terminal of capacitor C2) of the first power supply Bat through the switching transistor M1-Q1, the switching transistor M1-Q2, the first inductor L1, the body diode of the switching transistor M3-Q2, the body diode of the switching transistor M3-Q1, the capacitor C5 (i.e. the positive terminal of the photovoltaic system), and the capacitor C6 (i.e. the negative terminal of the photovoltaic system). During the process, the capacitor C1 and capacitor C2 are discharged, the capacitor C5 and capacitor C6 are charged, and the energy of the inductor L1 is charged or stored. As the capacitor C1 and the capacitor C2 are serially connected between the positive terminal of the first power supply Bat and the negative terminal of the first power supply Bat, the discharging of the capacitor C1 and the capacitor C2 means that the energy of the first power supply Bat also discharges. As the capacitor C5 and the capacitor C6 are serially connected between the positive terminal of the second power supply PV and the negative terminal of the second power supply PV, the charging of the capacitor C5 and the capacitor C6 means that the energy of the second power supply PV also charges.

2) As shown in FIG. 24, the first power supply Bat may also discharge the second power supply PV, which is an equivalent model of current flyback in a Buck mode.

During the current flyback, the switching transistors M1-Q1, M1-Q2, M4-Q1, and M4-Q2 are turned off. As shown in FIG. 24, the current flows from the first terminal of the inductor L1 to the second terminal of the inductor L1 through the body diode of the switching transistor M3-Q2, the body diode of the switching transistor M3-Q1, the capacitor C5, the capacitor C6, the body diode of the switching transistor M2-Q2, and the body diode of the switching transistor M2-Q1. During the process, the capacitor C5 and capacitor C6 are charged, and the energy of the inductor L1 is released. As the capacitor C5 and the capacitor C6 are serially connected between the positive terminal of the second power supply PV and the negative terminal of the second power supply PV, the charging of the capacitor C5 and the capacitor C6 means that the energy of the second power supply PV also charges.

Accordingly, the equivalent models of FIG. 25 and FIG. 24 are capable of discharging current to the capacitor C5 and the capacitor C6 from the capacitor C1 and the capacitor C2. Accordingly, the first power supply Bat may discharge current to the second power supply PV during the first Buck mode, i.e. the voltage down-converting mode.

3. The second Boost mode, i.e. the second power supply PV (i.e. the photovoltaic system) charges the first power supply Bat (i.e. the power battery pack):

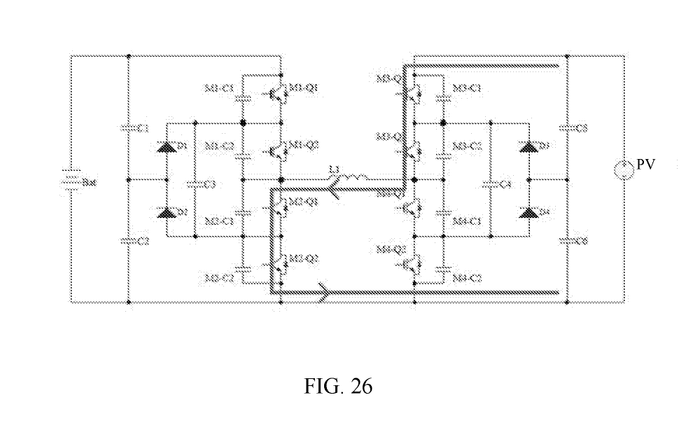

1) FIG. 26 is a diagram illustrating the second power supply PV charging the first power supply Bat in accordance with some embodiments. FIG. 26 shows an equivalent model of storing energy in a Boost mode.

During the storing energy, the switching transistors M3-Q1, M3-Q2, M2-Q1, and M2-Q2 are turned on, and the switching transistors M4-Q1, M4-Q2, M1-Q1, and M1-Q2 are turned off. As shown in FIG. 26, the current flows from the capacitor C5 (i.e. the positive terminal of the second power supply PV) to the capacitor C6 (i.e. the negative terminal of the second power supply PV) through the switching transistor M3-Q1, the switching transistor M3-Q2, the inductor L1, the switching transistor M2-Q1, and the switching transistor M2-Q2. During the process, the capacitor C5 and capacitor C6 are discharged, and the energy of the inductor L1 is charged or stored. As the capacitor C5 and the capacitor C6 are serially connected between the positive terminal of the second power supply PV and the negative terminal of the second power supply PV, the discharging of the capacitor C5 and the capacitor C6 means that the energy of the second power supply PV also discharges.

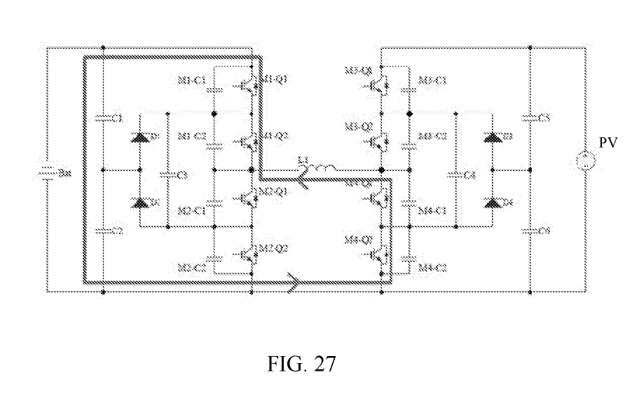

2) FIG. 27 is a diagram illustrating the second power supply PV discharging the first power supply Bat in accordance with some embodiments. FIG. 27 shows an equivalent model of current flyback in a Boost mode.

During the current flyback, the switching transistors M3-Q1 and M3-Q2 are turned on, and the switching transistors M4-Q1, M4-Q2, M2-Q1, and M2-Q2 are turned off. As shown in FIG. 27, the current flows from the first terminal of the inductor L1 to the second terminal of the inductor L1 through the body diode of the switching transistor M1-Q2, the body diode of the switching transistor M1-Q1, the capacitor C1 (i.e. the positive terminal of the first power supply Bat), the capacitor C2 (i.e. the negative terminal of the first power supply Bat), the body diode of the switching transistor M4-Q2, and the body diode of the switching transistor M4-Q1. During the process, the energy of the inductor L1 is released or discharged, and the capacitor C1 and the capacitor C2 are charged. As the capacitor C1 and the capacitor C2 are serially connected between the positive terminal of the first power supply Bat and the negative terminal of the first power supply Bat, the charging of the capacitor C1 and the capacitor C2 means that the energy of the first power supply Bat also charges.

Accordingly, the equivalent models of FIG. 26 and FIG. 27 are capable of discharging current to the capacitor C1 and the capacitor C2 from the capacitor C5 and the capacitor C6. Accordingly, the second power supply PV may charge current to the first power supply Bat during the second Boost mode, i.e. the voltage up-converting mode.

4. The second Buck mode, i.e. the second power supply PV (i.e. the photovoltaic system) charges the first power supply Bat (i.e. the power battery pack):

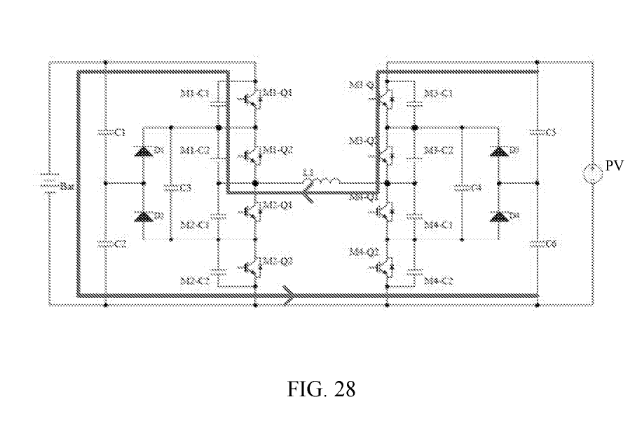

1) FIG. 28 is a diagram illustrating the second power supply PV charging the first power supply Bat in accordance with some embodiments. FIG. 28 shows an equivalent model of storing energy in a Buck mode.

During the storing energy, the switching transistors M3-Q1, M3-Q2, and M2-Q2 are turned on, and the switching transistors M4-Q1, M4-Q2, and M2-Q1 are turned off. As shown in FIG. 28, the current flows from the positive terminal (i.e. capacitor C5) of the second power supply PV to the negative terminal (i.e. the capacitor C6) of the second power supply PV through the switching transistor M3-Q1, the switching transistor M3-Q2, the inductor L1, the body diode of the switching transistor M1-Q2, the body diode of the switching transistor M1-Q1, the capacitor C1 (i.e. the positive terminal of the first power supply Bat), and the capacitor C2 (i.e. the negative terminal of the first power supply Bat). During the process, the capacitor C5 and capacitor C6 are discharged, the capacitor C1 and capacitor C1 are charged, and the energy of the inductor L1 is charged or stored. As the capacitor C1 and the capacitor C2 are serially connected between the positive terminal of the first power supply Bat and the negative terminal of the first power supply Bat, the charging of the capacitor C1 and the capacitor C2 means that the energy of the first power supply Bat also discharges. As the capacitor C5 and the capacitor C6 are serially connected between the positive terminal of the second power supply PV and the negative terminal of the second power supply PV, the discharging of the capacitor C5 and the capacitor C6 means that the energy of the second power supply PV also discharges.

2) As shown in FIG. 27, the second power supply PV may also charge the first power supply Bat based on the operation in the following paragraph, which is an equivalent model of current flyback in a Buck mode.

During the current flyback, the switching transistors M3-Q1, M3-Q2, M2-Q1, and M2-Q2 are turned off. As shown in FIG. 27, the current flows from the first terminal of the inductor L1 to the second terminal of the inductor L1 through the body diode of the switching transistor M1-Q2, the body diode of the switching transistor M1-Q1, the capacitor C1 (i.e. the positive terminal of the first power supply Bat), the capacitor C2 (i.e. the negative terminal of the first power supply Bat), the body diode of the switching transistor M4-Q2, and the body diode of the switching transistor M4-Q1. During the process, the energy of the inductor L1 is released or discharged, and the capacitor C1 and the capacitor C2 are charged. As the capacitor C1 and the capacitor C2 are serially connected between the positive terminal of the first power supply Bat and the negative terminal of the first power supply Bat, the charging of the capacitor C1 and the capacitor C2 means that the energy of the first power supply Bat also charges.

Accordingly, the equivalent models of FIG. 27 and FIG. 28 are capable of discharging current to the capacitor C1 and the capacitor C2 from the capacitor C5 and the capacitor C6. Accordingly, the second power supply PV may discharge current to the first power supply Ba during the second Buck mode, i.e. the voltage down-converting mode.

According to some embodiments, the DCDC double-direction converting device 2200 may be operated in the following four modes:

1. When the voltage level of the first power supply Bat is lower than the voltage level of the second power supply PV, the first power supply Bat discharges current to the second power supply PV.

2. When the voltage level of the first power supply Bat is higher than the voltage level of the second power supply PV, the first power supply Bat discharges current to the second power supply PV.

3. When the voltage level of the first power supply Bat is lower than the voltage level of the second power supply PV, the second power supply PV discharges current to the first power supply Bat.

4. When the voltage level of the first power supply Bat is higher than the voltage level of the second power supply PV, the second power supply PV discharges current to the first power supply Bat.

The above mentioned four controlling methods of the DCDC double-direction converting device 2200 is described in detail in the following paragraphs and diagrams.

1. When the voltage level of the first power supply Bat is lower than the voltage level of the second power supply PV, the first power supply Bat discharges current to the second power supply PV, and the controlling method is as followed:

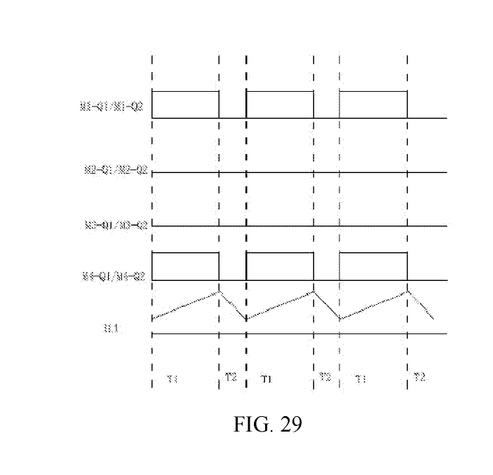

When the first power supply Bat is arranged to discharge current to the second power supply PV, and when the voltage level of the first power supply Bat is lower than the voltage level of the second power supply PV, the DCDC double-direction converting device 2200 is controlled to operate in a switching cycle having a first time interval T1 and a second time interval T2. During T2, detecting if the current of the inductor L1 crosses the zero current, if yes, controlling the DCDC double-direction converting device 2200 to operate in the time intervals T3, T4, or the time intervals T7, T8 after time interval T2. FIG. 29 is a timing diagram illustrating the signals in the time intervals T1˜T2 in accordance with some embodiments.

During the time interval T1, the switching transistors M1-Q1, M1-Q2, M4-Q1, and M4-Q2 are turned on, the switching transistors M2-Q1, M2-Q2, M3-Q1, and M3-Q2 are turned off. The current flow during the time interval T1 has been shown in FIG. 23, and the detailed description is omitted here for brevity. When the current of the inductor L1 flows to the right terminal from the left terminal, the current is defined as “positive” current. When the current of the second inductor L2 flows to the left terminal from the right terminal, the current is defined as “negative” current. In this process, the capacitors C1 and C2 are discharged, the current of the inductor L1 is positive current, the currents gradually increase, and the energy of the inductor L1 is stored until the time interval T2.

During the time interval T2, the switching transistors M4-Q1 and M4-Q2 are turned off, the bride circuits 2202 and 2204 are not turned on at the same time. During the time interval T2, the currents may have two directions.

The first current direction is happened when the switching transistors M1-Q1 and M1-Q2 are turned on. In this process, the energy of the inductor L1 is released. The current flow of this process has been shown in FIG. 25, and the detailed description is omitted here for brevity.

The second current direction is happened when the switching transistors M1-Q1 and M1-Q2 are turned off. In this process, the energy of the inductor L1 is released. The current flow of this process has been shown in FIG. 24, and the detailed description is omitted here for brevity.

In the above mentioned first current direction and the second current direction, the energy of the inductor L1 is released, the current is positive current, and the currents gradually decrease. Meanwhile, the capacitors C3 and C4 are charged by currents.

During the time interval T2, when the switching transistors M1-Q1 and M1-Q2 are turned off, the current flows through the body diode of the switching transistors M2-Q2 and the body diode of the switching transistors M2-Q1. During the time interval T1, the current flows through the switching transistors M1-Q1 and M1-Q2. Accordingly, when the time intervals T1 and T2 are combined, the two currents flow through the first bridge circuits 2202 and 2204 respectively. Therefore, the DCDC double-direction converting device 2200 may have better heat dissipation effect. According to some embodiments, the second current direction may be the better option in the time interval T2.

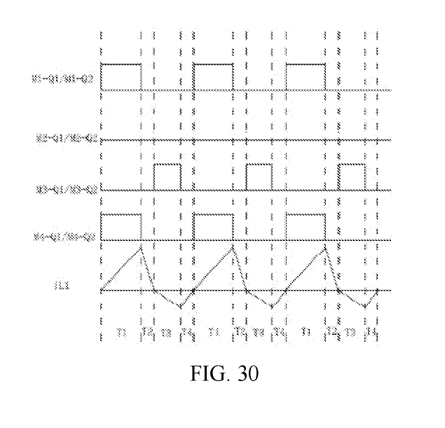

Moreover, during the time intervals T1 and T2, the first power supply Bat is arranged to boost the voltage level of the second power supply PV. The switching transistor M4-Q1 and M4-Q2 may be regarded as the high frequency transistors of the Boost circuit. When the switching transistor M4-Q1 and M4-Q2 have greater duty cycle (i.e. when T1 is greater than T2), the current of the inductor L1 is continuous, and the current is positive current. As shown in FIG. 29, when the duty cycle decreases to reach a specific value, the inductor current reaches the zero when the cycle finishes, and the next cycle begins at the same time. Then, the inductor L1 may store energy again, and the inductor currents increase, i.e. the threshold current mode. When the duty cycle is further reduced, i.e. the inductor current reach zero in the time interval T2, and the cycle is not finished yet, the DCDC double-direction converting device 2200 may enter the time intervals T3 and T4 or T7 and T8. FIG. 30 is a timing diagram illustrating the signals in the time intervals T1, T2, T3, and T4 in accordance with some embodiments.

During the time interval T3, the switching transistors M3-Q1 and M3-Q2 are turned on, the switching transistors M2-Q1 and M2-Q2 are turned off. The current flow of this process has been shown in FIG. 28, and the detailed description is omitted here for brevity. In this process, the capacitors C5 and C6 are discharged, and the capacitors C1 and C2 are charged. The energy of inductor L1 is stored, and the current increases. However, the inductor current is negative current.

During the time interval T4, the switching transistors M3-Q1, M3-Q2, M2-Q1, and M2-Q2 are turned off. The energy of the inductor L1 is released. The current flow of this process has been shown in FIG. 27, and the detailed description is omitted here for brevity. In this process, the energy of the inductor L1 is released, the current is negative current, and the current gradually decreases. Meanwhile, the capacitors C1 and C2 are charged by currents.

According to the time intervals T1˜T4, during the switching cycles, the currents of the inductor L1 is always continuous. In one cycle, if the first power supply Bat is arranged to discharge current to the second power supply PV, then the area formed by the positive current of the inductor L1 may be designed to be greater than the area formed by the negative current of the inductor L1. The different value of the two areas may be the discharging energy from the first power supply Bat to the second power supply PV.

Furthermore, when the voltage level of the first power supply Bat is lower than the voltage level of the second power supply PV, the DCDC double-direction converting device 2200 is arranged to operate in the time interval T3 before the currents of the inductor L1 crosses the zero current. Specifically, during the time interval T2, the switching transistors M3-Q1 and M3-Q2 are turned on, and the switching transistors M2-Q1 and M2-Q2 are turned off. Meanwhile, the current of the inductor L1 is positive current, and the current still flows through the body diode of the switching transistor M3-Q2 and the body diode of the switching transistor M3-Q1 to form a loop. As shown in FIG. 25 or FIG. 24, the direction of the current is similar to the current direction in the time interval T2. When the current of the inductor L1 reaches zero, the time interval T3 may start immediately to avoid the switching discontinuity when the time interval T2 proceeds to the next time interval T3.

Furthermore, during the time interval T4, the switching transistors M1-Q1, M1-Q2, M4-Q1, and M4-Q2 are turned on. Meanwhile, the current of the inductor L1 is negative current, the direction of the current is similar to the current direction in the time interval T4. As shown in FIG. 27, when the current of the inductor L1 reaches zero, the time interval T1 in the next cycle may start immediately to avoid the switching discontinuity when the time interval T4 proceeds to the next time interval T1.

In addition, during the time intervals T2 and T3, the switching transistor M1-Q1 is turned off. According to the time intervals T1˜T4, the switching transistors M1-Q2 and M2-Q1 are turned off in the whole switching cycle; the switching transistor M1-Q1 is controlled by the first control signal; the switching transistors M3-Q1 is controlled by the second control signal. To reduce the circuit complexity and to extend the lifetime of transistors, the second control signal may be the voltage inverted from the first control signal.

In another embodiment, during the time intervals T2 and T3, the switching transistor M1-Q1 is turned on. According to the time intervals T1˜T4, the switching transistors M1-Q1 and M1-Q2 are turned on in the whole switching cycle, the switching transistors M2-Q1 and M2-Q2 are turned off in the whole switching cycle to reduce the circuit complexity and to extend the lifetime of transistors.

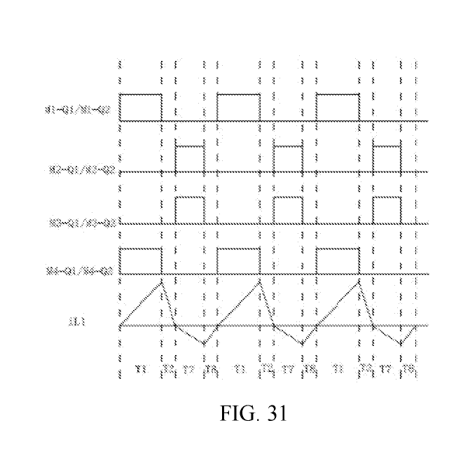

After the time intervals T1, T2, the DCDC double-direction converting device 2200 may be operated in the time intervals T7, T8 as shown in FIG. 31. FIG. 31 is a timing diagram illustrating the signals in the time intervals T1, T2, T7, and T8 in accordance with some embodiments.

During the time interval T7, the switching transistors M3-Q1, M3-Q2, M2-Q1, and M2-Q2 are turned on, the switching transistors M4-Q1, M4-Q2, M1-Q1, and M1-Q2 are turned off. The current flow of this process has been shown in FIG. 26, and the detailed description is omitted here for brevity. In this process, the capacitors C5 and C6 are discharged, and the inductor L1 is energy stored, and the currents increase. However, the inductor currents are negative current.

During the time interval T8, the switching transistors M2-Q1 and M2-Q2 are turned off, and the first bridge circuits 2202 and 2204 are not turned on at the same time. During the time interval T8, the currents may have two directions.

The first current direction is happened when the switching transistors M3-Q1 and M3-Q2 are turned on, and the switching transistors M4-Q2 and M4-Q1 are turned off as shown in FIG. 28. In this process, the energy of the inductor L1 is released. The current flow of this process has been shown in FIG. 28, and the detailed description is omitted here for brevity.

The second current direction is happened when the switching transistors M3-Q1 and M3-Q2 are turned off. In this process, the energy of the inductor L1 is released. The current flow of this process has been shown in FIG. 27, and the detailed description is omitted here for brevity.

In the above mentioned first current direction and the second current direction, the energy of the inductor L1 is released, the current is negative current, the current gradually decreases, and the capacitors C1 and C2 are charged.

During the time interval T8, the switching transistors M3-Q1 and M3-Q2 are turned off such that the current flows through the body diodes of the switching transistors M4-Q2 and M4-Q1. During the time interval T7, the current flows through the switching transistors M3-Q1 and M3-Q2. When the time intervals T7 and T8 are combined, the currents flow through different bridge circuits in different time intervals. Therefore, the DCDC double-direction converting device 2200 may have better heat dissipation effect. According to some embodiments, the second current direction may be the better option in the time interval T8.

According to the time intervals T1, T2, T7, T8, during the switching cycles, the currents of the inductors are continuous.

Furthermore, the DCDC double-direction converting device 2200 is arranged to operate in the time interval T7 before the currents of the inductor L1 crosses the zero current. Specifically, during the time interval T2, the switching transistors M2-Q1, M2-Q2, M3-Q1, and M3-Q2 are turned on. Meanwhile, when the current of the inductor L1 is positive current, the direction of the current is similar to the current direction in the time interval T2 as shown in FIG. 25 or FIG. 24. When the current of the inductor L1 reaches zero, the time interval T7 may start immediately to avoid the switching discontinuity when the time interval T2 proceeds to the next time interval T7.

Furthermore, during the time interval T8, the switching transistors M1-Q1, M1-Q2, M4-Q1, and M4-Q2 are turned on, and the switching transistors M3-Q1 and M3-Q2 are turned off. Meanwhile, when the current of the inductor L1 is negative current, the direction of the current is similar to the current direction in the time interval T8 as shown in FIG. 28 or FIG. 27. When the current of the inductor L1 reaches zero, the time interval T1 in the next cycle may start immediately to avoid the switching discontinuity when the time interval T8 proceeds to the next time interval T1.

Furthermore, during the time interval T8, the switching transistors M1-Q1 and M1-Q2 are turned off. According to the time intervals T1, T2, T7, and T8, the switching transistors M1-Q1, M1-Q2, M4-Q1, and M4-Q2 are controlled by the first control signal; the switching transistors M2-Q1, M2-Q2, M3-Q1, and M3-Q2 are controlled by the second control signal. To reduce the circuit complexity and to extend the lifetime of transistors, the second control signal may be the voltage inverted from the first control signal.

2. When the voltage level of the first power supply Bat is higher than the voltage level of the second power supply PV, the first power supply Bat is arranged to discharge current to the second power supply PV according to the following method:

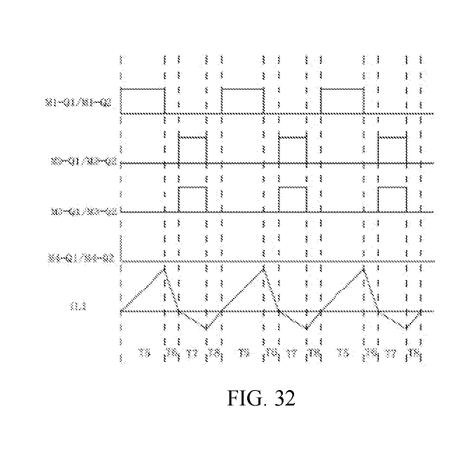

When the first power supply Bat is arranged to discharge current to the second power supply PV, and when the voltage level of the first power supply Bat is higher than the voltage level of the second power supply PV, the DCDC double-direction converting device 2200 is controlled to operate in a switching cycle having the time interval T5 and the time interval T6. During T6, detecting if the current of the inductor L1 crosses the zero current, if yes, controlling the DCDC double-direction converting device 2200 to operate in the time intervals T7, T8, or the time intervals T3, T4 after time interval T6. After the time intervals T5, T6, the DCDC double-direction converting device 2200 may be controlled to operate in the time intervals T7, T8 as shown in FIG. 32.

During the time interval T5, the switching transistors M1-Q1 and M1-Q2 are turned on, and the switching transistors M4-Q1 and M4-Q2 are turned off. The current flow during the time interval T5 has been shown in FIG. 25, and the detailed description is omitted here for brevity. In this process, the capacitors C1 and C2 are discharged, and the capacitors C5 and C6 are charged, and the inductor L1 is energy stored.

During the time interval T6, the switching transistors M1-Q1, M1-Q2, M4-Q1, and M4-Q2 are turned off. The energy of the inductors L1 is released. The current flow during the time interval T6 has been shown in FIG. 24, and the detailed description is omitted here for brevity. In this process, the inductor L1 is energy released, the current of the inductor L1 is positive current, and the current gradually decreases. The capacitors C5 and C6 are charged.

During the time intervals T5, T6, the first power supply Bat is arranged to generate the reduced voltage level to the second power supply PV. The switching transistor M1-Q1 and M2-Q2 may be regarded as the high frequency transistors of the Buck circuit. When the switching transistor M1-Q1 and M2-Q2 have greater duty cycle (i.e. when T5 is greater than T6), the current of the inductor L1 is continuous, and the current in T5 and T6 is positive current. When the duty cycle decreases to reach a specific value, the inductor current reaches the zero when the cycle finishes and the next cycle begins at the same time. Then, the inductor may store energy again, and the inductor current increases, i.e. the threshold current mode. When the duty cycle is further reduced, i.e. the inductor currents reach zero in the time interval T6, and the cycle is not finished yet, the DCDC double-direction converting device 2200 may enter the time intervals T7 and T8 as shown in FIG. 32.

The time intervals T7 and T8 has been described, and the detailed description is omitted here for brevity.

According to the time intervals T5˜T8, during the switching cycles, the currents of the inductors are always continuous.

Furthermore, when the voltage level of the first power supply Bat is higher than the voltage level of the second power supply PV, the DCDC double-direction converting device 2200 is arranged to operate in the time interval T7 before the currents of the inductor L1 crosses the zero current. Specifically, during the time interval T6, the switching transistors M2-Q1, M2-Q2, M3-Q1, and M3-Q2 are turned on. Meanwhile, the current of the inductor L1 is positive current, the direction of the current is similar to the current direction in the time interval T6 as shown in FIG. 24. When the current of the inductor L1 reaches zero, the time interval T7 may start immediately to avoid the switching discontinuity when the time interval T6 proceeds to the next time interval T7.

Furthermore, during the time interval T8, the switching transistors M1-Q1 and M1-Q2 are turned on, and the switching transistors M4-Q1 and M4-Q2 are turned off. Meanwhile, the current of the inductor L1 is negative current, the direction of the current is similar to the current direction in the time interval T8. As shown in FIG. 28 or FIG. 27, when the current of the inductor L1 reaches zero, the time interval T5 in the next cycle may start immediately to avoid the switching discontinuity when the time interval T8 proceeds to the next time interval T5.

In addition, during the time intervals T5 and T8, the switching transistors M3-Q1 and M3-Q2 are turned off. According to the time intervals T5˜T8, the switching transistors M4-Q1 and M4-Q2 are turned off in the whole switching cycle; the switching transistors M1-Q1 and M1-Q2 are controlled by the first control signal; the switching transistors M2-Q1, M2-Q2, M3-Q1, and M3-Q2 are controlled by the second control signal. To reduce the circuit complexity and to extend the lifetime of transistors, the second control signal may be the voltage inverted from the first control signal.

In another embodiment, during the time intervals T5 and T8, the switching transistors M3-Q1 and M3-Q2 are turned on. According to the time intervals T5˜T8, the switching transistors M4-Q1 and M4-Q2 are turned on in the whole switching cycle, the switching transistors M3-Q1 and M3-Q2 are turned off in the whole switching cycle; the switching transistors M1-Q1 and M1-Q2 are controlled by the first control signal; the switching transistors M2-Q1 and M2-Q2 are controlled by the second control signal. To reduce the circuit complexity and to extend the lifetime of transistors, the second control signal may be the voltage inverted from the first control signal.

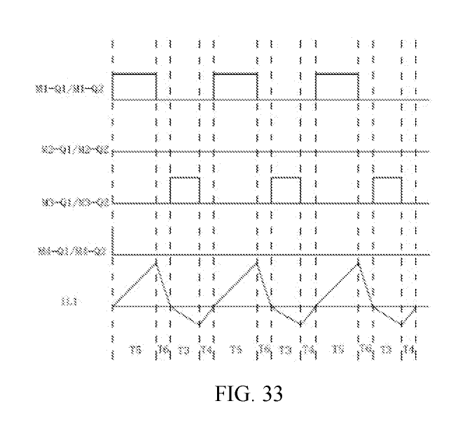

After the time intervals T5 and T6, the DCDC double-direction converting device 2200 may be operated in the time intervals T3 and T4. The current direction of the currents in the time intervals T5, T6, T3, and T4 are shown in FIG. 33, the detailed description is omitted here for brevity.

Furthermore, when the voltage level of the first power supply Bat is higher than the voltage level of the second power supply PV, the DCDC double-direction converting device 2200 is arranged to operate in the time interval T3 before the current of the inductor L1 crosses the zero current. Specifically, during the time interval T6, the switching transistors M3-Q1 and M3-Q2 are turned on, and the switching transistors M2-Q1 and M2-Q2 are turned off. Meanwhile, the current of the inductor L1 is positive current, and the current flows through the body diode of the switching transistor M3-Q2 and the body diode of the switching transistor M3-Q1 to release energy. As shown in FIG. 24, the direction of the current is similar to the current direction in the time interval T6. When the current of the inductor L1 reaches zero, the time interval T3 may start immediately to avoid the switching discontinuity when the time interval T6 proceeds to the next time interval T3.

Furthermore, during the time interval T4, the switching transistors M1-Q1 and M1-Q2 are turned on, and the switching transistors M4-Q1 and M4-Q2 are turned off. Meanwhile, the current of the inductor L1 is negative current, the direction of the current is similar to the current direction in the time interval T4. As shown in FIG. 27, when the current of the inductor L1 reaches zero, the time interval T5 in the next cycle may start immediately to avoid the switching when the time interval T4 proceeds to the next time interval T5.

In addition, during the time interval T5, the switching transistors M3-Q1 and M3-Q2 are turned off. During the time interval T3, the switching transistors M1-Q1 and M1-Q2 are turned off. When the time intervals T5, T6, T3, and T4 are combined, the switching transistors M2-Q1, M2-Q2, M4-Q1, and M4-Q2 are turned off in the whole switching cycle; the switching transistors M1-Q1 and M1-Q2 are controlled by the first control signal; the switching transistors M3-Q1 and M3-Q2 are controlled by the second control signal. To reduce the circuit complexity and to extend the lifetime of transistors, the second control signal may be the voltage inverted from the first control signal.

According to the above methods, the switching transistors in a bridge circuit are turned on or turned off at the same time. In practice, the turn-on time or turn-off time of the first switching transistor and the second switching transistor in a same bridge circuit may be increased or decreased. Specifically, when the first switching transistor and the second switching transistor in a same bridge circuit are turned off, the outside transistor (i.e. the M1-Q1 of the first bridge circuit 2202, the M2-Q2 of the second bridge circuit 2204, the M3-Q1 of the third bridge circuit 2206, the M4-Q2 of the fourth bridge circuit 2208) in the same bridge circuit may be turned off early to avoid the damage of the outside transistor that is caused by the voltage level of the first power supply Bat or the second power supply PV.

According to the above mentioned methods, no matter the voltage level of the first power supply Bat is higher or lower than the voltage level of the second power supply PV, the first power supply Bat may discharge current to the second power supply PV, i.e. the second power supply PV is charged. In the process, the first power supply Bat of the DCDC double-direction converting device 2200 may be regarded as the power supply source, and the second power supply PV may be regarded as the loading that consumes power. Similarly, the second power supply PV may be arranged to discharge current to the first power supply Bat. The second power supply PV may use the similar method to discharge current to the first power supply Bat by switching the roles between the second power supply PV and the first power supply Bat. Specifically, the switching transistor M1-Q1 corresponds to the switching transistor M3-Q1; the switching transistor M1-Q2 corresponds to the switching transistor M3-Q2; the switching transistor M2-Q1 corresponds to the switching transistor M4-Q1; and the switching transistor M2-Q2 corresponds to the switching transistor M4-Q2.

3. When the voltage level of the first power supply Bat is lower than the voltage level of the second power supply PV, the second power supply PV discharges current to the first power supply Bat.

When the second power supply PV is arranged to discharge current to the first power supply Bat, and when the voltage level of the second power supply PV is lower than the voltage level of the first power supply Bat, the DCDC double-direction converting device 2200 is controlled to operate in a switching cycle having the time intervals T1′ and T2′. During T2′, detecting if the current of the inductor L1 crosses the zero current, if yes, controlling the DCDC double-direction converting device 2200 to operate in the time intervals T3′, T4′, or the time intervals T7′, T8′ after time interval T2′. The detailed description of T1′˜T4′, T7′, and T8′ is described in below:

During the time intervals T1′: the switching transistors M3-Q1, M3-Q2, M2-Q1, and M2-Q2 are turned on, and the switching transistors M4-Q1, M4-Q2, M1-Q1, and M1-Q2 are turned off;

During the time intervals T2′: the switching transistors M2-Q1 and M2-Q2 are turned off, and the third bridge circuit 2206 and the fourth bridge circuit 2208 are not turned on at the same time;

During the time intervals T3′: the switching transistors M1-Q1 and M1-Q2 are turned on; and the switching transistors M4-Q1 and M4-Q2 are turned off;

During the time intervals T4′: the switching transistors M1-Q1, M1-Q2, M4-Q1, and M4-Q2 are turned off;

During the time intervals T7′: the switching transistors M1-Q1, M1-Q2, M4-Q1, and M4-Q2 are turned on, the switching transistors M2-Q1, M2-Q2, M3-Q1, and M3-Q2 are turned off;

During the time intervals T8′: the switching transistors M4-Q1 and M4-Q2 are turned off, and the third bridge circuit 2206 and the fourth bridge circuit 2208 are not turned on at the same time.

4. When the voltage level of the first power supply Bat is higher than the voltage level of the second power supply PV, the second power supply PV discharges current to the first power supply Bat.

When the second power supply PV is arranged to discharge current to the first power supply Bat, and when the voltage level of the second power supply PV is higher than the voltage level of the first power supply Bat, the DCDC double-direction converting device 2200 is controlled to operate in a switching cycle having the time intervals T5′ and T6′. During T5′, detecting if the current of the inductor L1 crosses the zero current, if yes, controlling the DCDC double-direction converting device 2200 to operate in the time intervals T7′, T8′, or the time intervals T3′, T4′ after time interval T6′. The detailed description of T5′˜T8′, T3′, and T4′ is described in below:

During the time intervals T5′: the switching transistors M3-Q1 and M3-Q2 are turned on, and the switching transistors M2-Q1 and M2-Q2 are turned off;

During the time intervals T6′: the switching transistors M3-Q1, M3-Q2, M2-Q1, and M2-Q2 are turned off;

During the time intervals T7′: the switching transistors M1-Q1, M1-Q2, M4-Q1, and M4-Q2 are turned on; and the switching transistors M2-Q1, M2-Q2, M3-Q1, and M3-Q2 are turned off;

During the time intervals T8′: the switching transistors M4-Q1 and M4-Q2 are turned off, and the third bridge circuit 2206 and the fourth bridge circuit 2208 are not turned on at the same time;

During the time intervals T3′: the switching transistors M1-Q1 and M1-Q2 are turned on, the switching transistors M4-Q1 and M4-Q2 are turned off;

During the time intervals T4′: the switching transistors M1-Q1, M1-Q2, M4-Q1, and M4-Q2 are turned off.

Similarly, when the second power supply PV is arranged to discharge current to the first power supply Bat, i.e. the first power supply Bat is charged, the second power supply PV of the DCDC double-direction converting device 2200 may be regarded as the power supply source, and the first power supply Bat may be regarded as the loading that consumes power.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A voltage converting device, comprising:
a first power supply, having a first positive terminal and a first negative terminal;
a first bridge circuit, coupled to the first positive terminal;
a second bridge circuit, coupled between the first bridge circuit and the first negative terminal;
a second power supply, having a second positive terminal and a second negative terminal;
a third bridge circuit, coupled to the second positive terminal;
a fourth bridge circuit, coupled between the third bridge circuit and the second negative terminal; and
an inductive circuit, coupled between the first bridge circuit and the second bridge circuit.

2. The voltage converting device of claim 1, wherein the first power supply is a power battery pack and the second power supply is a photovoltaic system.

3. The voltage converting device of claim 1, wherein the first bridge circuit comprises:
a first capacitor, having a first terminal coupled to the first positive terminal;
a first switching transistor, having a first terminal coupled to the first terminal of the first capacitor; and
a second switching transistor, having a first terminal coupled to a second terminal of the first switching transistor, and a second terminal coupled to a second terminal of the first capacitor;
the second bridge circuit comprises:
a second capacitor, having a first terminal coupled to the second terminal of the first capacitor, and a second terminal coupled to the first negative terminal of the first power supply;
a third switching transistor, having a first terminal coupled to the first terminal of the second capacitor; and
a fourth switching transistor, having a first terminal coupled to a second terminal of the third switching transistor, and a second terminal coupled to the second terminal of the first capacitor;
the third bridge circuit comprises:
a third capacitor, having a first terminal coupled to the second positive terminal;
a fifth switching transistor, having a first terminal coupled to the first terminal of the third capacitor; and
a sixth switching transistor, having a first terminal coupled to a second terminal of the fifth switching transistor, and a second terminal coupled to a second terminal of the third capacitor;
the fourth bridge circuit comprises:
a fourth capacitor, having a first terminal coupled to the second terminal of the third capacitor, and a second terminal coupled to the second negative terminal of the second power supply;
a seventh switching transistor, having a first terminal coupled to the first terminal of the fourth capacitor; and
an eighth switching transistor, having a first terminal coupled to a second terminal of the seventh switching transistor, and a second terminal coupled to the second terminal of the fourth capacitor; and
the inductive circuit comprises:
a first inductor, having a first terminal coupled to the second terminal of the first switching transistor, and a second terminal coupled to the second terminal of the fifth switching transistor; and
a second inductor, having a first terminal coupled to the second terminal of the third switching transistor, and a second terminal coupled to the second terminal of the seventh switching transistor.

4. The voltage converting device of claim 3, wherein the first capacitor, the second capacitor, the third capacitor, and the fourth capacitor have a first capacitance, a second capacitance, a third capacitance, and a fourth capacitance respectively, the first capacitance is equal to the second capacitance, and the third capacitance is equal to the fourth capacitance.

5. The voltage converting device of claim 3, wherein the second terminal of the second switching transistor is coupled to the second terminal of the sixth switching transistor.

6. The voltage converting device of claim 1, further comprising:
a first connecting circuit, coupled to the first positive terminal, the first negative terminal, the first bridge circuit, and the second bridge circuit; and
a second connecting circuit, coupled to the second positive terminal, the second negative terminal, the third bridge circuit, and the fourth bridge circuit.

7. The voltage converting device of claim 6, wherein the first bridge circuit comprises:
a first capacitor, having a first terminal coupled to the first positive terminal;
a first switching transistor, having a first terminal coupled to the first terminal of the first capacitor, and a second terminal coupled to a second terminal of the first capacitor;
a second capacitor, having a first terminal coupled to the second terminal of the first capacitor; and
a second switching transistor, having a first terminal coupled to the first terminal of the second capacitor, and a second terminal coupled to a second terminal of the first capacitor;
the second bridge circuit comprises:
a third capacitor, having a first terminal coupled to the second terminal of the second capacitor;
a third switching transistor, having a first terminal coupled to the first terminal of the third capacitor, and a second terminal coupled to a second terminal of the third capacitor;
a fourth capacitor, having a first terminal coupled to the second terminal of the third capacitor; and
a fourth switching transistor, having a first terminal coupled to the first terminal of the fourth capacitor, and a second terminal coupled to a second terminal of the fourth capacitor;
the third bridge circuit comprises:
a fifth capacitor, having a first terminal coupled to the second positive terminal;
a fifth switching transistor, having a first terminal coupled to the first terminal of the fifth capacitor, and a second terminal coupled to a second terminal of the fifth capacitor;
a sixth capacitor, having a first terminal coupled to the second terminal of the fifth capacitor; and
a sixth switching transistor, having a first terminal coupled to the first terminal of the sixth capacitor, and a second terminal coupled to a second terminal of the sixth capacitor;
the fourth bridge circuit comprises:
a seventh capacitor, having a first terminal coupled to the second terminal of the sixth capacitor;
a seventh switching transistor, having a first terminal coupled to the first terminal of the seventh capacitor, and a second terminal coupled to a second terminal of the seventh capacitor;
an eighth capacitor, having a first terminal coupled to the second terminal of the seventh capacitor; and
an eighth switching transistor, having a first terminal coupled to the first terminal of the eighth capacitor, and a second terminal coupled to a second terminal of the eighth capacitor; and
the inductive circuit comprises:
an inductor, having a first terminal coupled to the second terminal of the second switching transistor, and a second terminal coupled to the second terminal of the sixth switching transistor.

8. The voltage converting device of claim 7, wherein the first capacitor, the second capacitor, the third capacitor, the fourth capacitor, the fifth capacitor, the sixth capacitor, the seventh capacitor, and the eighth capacitor have a first capacitance, a second capacitance, a third capacitance, a fourth capacitance, a fifth capacitance, a sixth capacitance, a seventh capacitance, and an eighth capacitance respectively, the first capacitance and the second capacitance are equal to the third capacitance and the fourth capacitance respectively, and the fifth capacitance and the sixth capacitance are equal to the seventh capacitance and the eighth capacitance respectively.

9. The voltage converting device of claim 7, wherein the first connecting circuit comprises:
a ninth capacitor, having a first terminal coupled to the first positive terminal;
a tenth capacitor, having a first terminal coupled to a second terminal of the ninth capacitor, and a second terminal coupled to the first negative terminal;
an eleventh capacitor, having a first terminal coupled to the second terminal of the first capacitor, and a second terminal coupled to the second terminal of the third capacitor;
a first diode, having an anode coupled to the second terminal of the ninth capacitor, and a cathode coupled to the first terminal of the eleventh capacitor; and
a second diode, having an anode coupled to the second terminal of the eleventh capacitor, and a cathode coupled to the second terminal of the ninth capacitor; and
the second connecting circuit comprises:
a twelfth capacitor, having a first terminal coupled to the second positive terminal;
a thirteenth capacitor, having a first terminal coupled to a second terminal of the twelfth capacitor, and a second terminal coupled to the second negative terminal;
a fourteenth capacitor, having a first terminal coupled to the second terminal of the fifth capacitor and a second terminal coupled to the seventh capacitor;
a third diode, having an anode coupled to the second terminal of the twelfth capacitor, and a cathode coupled to the first terminal of the fourteenth capacitor; and
a fourth diode, having an anode coupled to the second terminal of the fourteenth capacitor, and a cathode coupled to the second terminal of the twelfth capacitor.

10. A method of controlling a voltage converting device, wherein the voltage converting device comprises:
a first power supply, having a first positive terminal and a first negative terminal;
a first bridge circuit, having a first switching transistor and a second switching transistor, coupled to the first positive terminal;
a second bridge circuit, having a third switching transistor and a fourth switching transistor, coupled between the first bridge circuit and the first negative terminal;
a second power supply, having a second positive terminal and a second negative terminal;
a third bridge circuit, having a fifth switching transistor and a sixth switching transistor, coupled to the second positive terminal; and
a fourth bridge circuit, having a seventh switching transistor and an eight switching transistor, coupled between the third bridge circuit and the second negative terminal; and
an inductive circuit, coupled between the first bridge circuit and the second bridge circuit; and
the method comprises:
receiving a request for discharging current to the second power supply from the first power supply;
detecting a first voltage level of the first power supply and a second voltage level of the second power supply;
when the first voltage level is smaller than the second voltage level:
controlling the voltage converting device to operate in a first cycle having a first time interval T1 and a second time interval T2;
during the second time interval T2, detecting if a current of the inductive circuit crosses a zero current; and
when the current crosses the zero current in the second time interval T2, controlling the voltage converting device to operate in a second cycle having a third time interval T3 and a fourth time interval T4 or a third cycle having a seventh time interval T7 and an eighth interval T8 after the second time interval T2;
when the first voltage level is higher than the second voltage level:
controlling the voltage converting device to operate in a fourth cycle having a fifth time interval T5 and a sixth time interval T6;
during the sixth time interval T6, detecting if the current of the inductive circuit crosses the zero current; and
when the current crosses the zero current in the sixth time interval T6, controlling the voltage converting device to operate in a fifth cycle having the third time interval T3 and the fourth time interval T4 or a sixth cycle having the seventh time interval T7 and the eighth interval T8, or a seventh cycle having the third time interval T3 and the fourth time interval T4 after the sixth time interval T6.

11. The method of claim 10, wherein:
during the first time interval T1, the first switching transistor and the sixth switching transistor are turned on, the second switching transistor and the fifth switching transistor are turned off;
during the second time interval T2, the sixth switching transistor is turned off;
during the third time interval T3, the fifth switching transistor is turned on, the second switching transistor and the sixth switching transistor are turned off;
during the fourth time interval T4, the second switching transistor and the fifth switching transistor are turned off;
during the fifth time interval T5, the first switching transistor is turned on, the second switching transistor and the sixth switching transistor are turned off;
during the sixth time interval T6, the first switching transistor and the sixth switching transistor are turned off;
during the seventh time interval T7, the second switching transistor and the fifth switching transistor are turned on, the first switching transistor and the sixth switching transistor are turned off; and
during the eighth time interval T8, the second switching transistor is turned off;
wherein the fourth switching transistor and the first switching transistor are controlled by a first signal, the third switching transistor and the second switching transistor are controlled by a second signal, the eight switching transistor and the fifth switching transistor are controlled by a third signal, and the seventh switching transistor and the sixth switching transistor are controlled by a fourth signal.

12. The method of claim 11, wherein, during a cycle having time intervals T1, T2, T3, T4, the voltage converting device is arranged to operate in the third interval T3 before the current crosses the zero current; during a cycle having time intervals T1, T2, T7, T8, the voltage converting device is arranged to operate in the seventh interval T7 before the current crosses the zero current; during a cycle having time intervals T5, T6, T7, T8, the voltage converting device is arranged to operate in the seventh interval T7 before the current crosses the zero current; and during a cycle having time intervals T5, T6, T3, T4, the voltage converting device is arranged to operate in the third interval T3 before the current crosses the zero current.

13. The method of claim 11, wherein, during a cycle having time intervals T1, T2, T3, T4, the fifth switching transistor is turned on and the second switching transistor is turned off in the second interval T2; during a cycle having time intervals T1, T2, T7, T8, the second switching transistor and the fifth switching transistor are turned on in the second interval T2; during a cycle having time intervals T5, T6, T7, T8, the second switching transistor and the fifth switching transistor are turned on in the sixth interval T6; and during a cycle having time intervals T5, T6, T3, T4, the fifth switching transistor is turned on and the second switching transistor is turned off in the sixth interval T6.

14. The method of claim 13, wherein, during the cycle having time intervals T1, T2, T3, T4, the first switching transistor and the sixth switching transistor are turned on in the fourth interval T4; during the cycle having time intervals T1, T2, T7, T8, the first switching transistor and the sixth switching transistor are turned on in the eighth interval T8; during the cycle having time intervals T5, T6, T7, T8, the first switching transistor is turned on and the sixth switching transistor is turned off in the eighth interval T8; and during the cycle having time intervals T5, T6, T3, T4, the first switching transistor and the sixth switching transistor are turned off in the fourth interval T4.

15. The method of claim 14, wherein the first switching transistor is turned off in the second interval T2, and the fifth switching transistor is turned off in the eighth interval T8.

16. The method of claim 15, wherein the first switching transistor is turned on in the third interval T3, and the fifth switching transistor is turned on in the fifth interval T5.

17. The method of claim 10, wherein:
during the first time interval T1, the first bridge circuit and the fourth bridge circuit are turned on, and the second bridge circuit and the third bridge circuit are turned off;
during the second time interval T2, the fourth bridge circuit is turned off, and the first bridge circuit and the second bridge circuit are not turned on at the same time;
during the third time interval T3, the third bridge circuit is turned on, and the second bridge circuit and the fourth bridge circuit are turned off;
during the fourth time interval T4, the second bridge circuit and the third bridge circuit are turned off;
during the fifth time interval T5, the first bridge circuit is turned on, and the second bridge circuit and the fourth bridge circuit are turned off;
during the sixth time interval T6, the first bridge circuit and the fourth bridge circuit are turned off;
during the seventh time interval T7, the second bridge circuit and the third bridge circuit are turned on, and the first bridge circuit and the fourth bridge circuit are turned off; and
during the eighth time interval T8, the second bridge circuit is turned off, and the third bridge circuit and the fourth bridge circuit are not turned on at the same time.

18. The method of claim 17, wherein, during a cycle having time intervals T1, T2, T3, T4, the third bridge circuit is turned on and the second bridge circuit is turned off in the second interval T2; during a cycle having time intervals T1, T2, T7, T8, the second bridge circuit and the third bridge circuit are turned on in the second interval T2; during a cycle having time intervals T5, T6, T7, T8, the second bridge circuit and the third bridge circuit are turned on in the sixth interval T6; and during a cycle having time intervals T5, T6, T3, T4, the third bridge circuit is turned on and the second bridge circuit is turned off in the sixth interval T6.

19. The method of claim 18, wherein, during the cycle having time intervals T1, T2, T3, T4, the first bridge circuit and the fourth bridge circuit are turned on in the fourth interval T4; during the cycle having time intervals T1, T2, T7, T8, the first bridge circuit and the fourth bridge circuit are turned on and the third bridge circuit is turned off in the eighth interval T8; during the cycle having time intervals T5, T6, T7, T8, the first bridge circuit is turned on and the fourth bridge circuit is turned off in the eighth interval T8; and during the cycle having time intervals T5, T6, T3, T4, the first bridge circuit is turned on and the fourth bridge circuit is turned off in the fourth interval T4.

20. The method of claim 19, wherein the first bridge circuit is turned off in the second interval T2, the third bridge circuit is turned off in the eighth interval T8, the first bridge circuit is turned on in the third interval T3, and the third bridge circuit is turned on in the fifth interval T5.
